(19) United States
(12) Patent Application Publication
(10) Pub. No.: US 2025/0045972 A1
(43) Pub. Date: Feb. 6, 2025

(54) POINT CLOUD PROCESSING METHOD AND APPARATUS, COMPUTER DEVICE, AND STORAGE MEDIUM

(71) Applicant: TENCENT TECHNOLOGY ( SHENZHEN) COMPANY LIMITED, Shenzhen (CN)

(72) Inventor: Wenjie ZHU, Shenzhen (CN)

(73) Assignee: TENCENT TECHNOL0GY (SHENZHEN) COMPAY LIMITED, Shenzhen (CN)

(21) Appl. No.: 18/921,685

(22) Filed: Oct. 21, 2024

Related U.S. Application Data
(63) Continuation of application No. PCT/CN2023/079140, filed on Mar. 1, 2023.

(30) Foreign Application Priority Data
Jun. 18, 2022 (CN) 202210717592.3

(51) Int. Cl. G06T 9/00; G06T 9/40

(52) U.S. Cl. CPC G06T 9/001; G06T 9/40; G06T 2219/012

(57) ABSTRACT

A point cloud processing method, performed by a decoding device, includes: obtaining coding data of a point cloud; determining a coding schemes of a first point to be decoded in the point cloud, in K directions, based on the coding data; and decoding the first point based on the determined plurality of coding schemes, wherein K is a positive integer.

### CROSS-REFERENCE TO RELATED APPLICATIONS

This application is a continuation application of International Application No. PCT/CN2023/079140 filed on Mar. 1, 2023, which claims priority to Chinese Patent Application No. 202210717592.3 filed with the China National Intellectual Property Administration on Jun. 18, 2022, the disclosures of each being incorporated by reference herein in their entireties.

### FIELD

This disclosure relates to the field of computer technologies, in particular to the field of coding and decoding technologies, and to a point cloud processing method, a point cloud processing apparatus, a computer device, and a storage medium.

### BACKGROUND

With the continuous development of science and technology, a large number of high-precision point clouds may be obtained at a low cost within a short period of time. The point cloud may include a plurality of points, and each point of the point cloud may have geometry information and attribute information. For transmission efficiency of the point cloud, the point cloud may require coding before transmitted, however.

### SUMMARY

Provided are a point cloud processing method and apparatus, a computer device, and a storage medium.

According some embodiments, a point cloud processing method includes: obtaining coding data of a point cloud; determining a coding schemes of a first point to be decoded in the point cloud, in K directions, based on the coding data; and decoding the first point based on the determined plurality of coding schemes, wherein K is a positive integer.

According some embodiments, a point cloud processing apparatus includes: at least one memory configured to store computer program code; at least one processor configured to read the program code and operate as instructed by the program code, the program code including: obtaining code configured to cause at least one of the at least one processor to obtain coding data of a point cloud; determining code configured to cause at least one of the at least one processor to determine a plurality of coding schemes of a first point to be decoded in the point cloud in a plurality of K directions, based on the coding data, and decoding code configured to cause at least one of the at least one processor to decode the first point based on the determined plurality of coding schemes, wherein K is a positive integer.

According to some embodiments, a non-transitory computer-readable storage medium, storing computer code which, when executed by at least one processor, causes the at least one processor to at least: obtain coding data of a point cloud; determine a plurality of coding schemes of a first point to be decoded in the point cloud in a plurality of K directions, based on the coding data, and decode the first point based on the determined plurality of coding schemes, wherein K is a positive integer.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic flowchart of point cloud compression (PCC) according to some embodiments.

FIG. 2 is a diagram of a bounding box according to some embodiments.

FIG. 3 is a diagram of octree coding according to some embodiments.

FIG. 4 is a diagram of a prediction tree coding structure according to some embodiments.

FIG. 5 is a diagram of another prediction tree coding structure according to some embodiments.

FIG. 6 is a diagram of a structure of a point cloud processing system according to some embodiments.

FIG. 7 is a schematic flowchart of a point cloud processing method according to some embodiments.

FIG. 8 is a schematic flowchart of another point cloud processing method according to some embodiments.

FIG. 9 is a diagram of a included sign determining process according to some embodiments.

FIG. 10 is a diagram of a structure of a point cloud processing apparatus according to some embodiments.

FIG. 11 is a diagram of a structure of another point cloud processing apparatus according to some embodiments.

FIG. 12 is a diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

To improve transmission efficiency of a point cloud, the point cloud may may be coded before transmission. A coder side may code geometry information and attribute information of each point in the point cloud, and may transmits a coded point cloud to a decoder side. The decoder side may decode the coded point cloud to reconstruct the geometry information and the attribute information of each point in the point cloud.

The point cloud may be characterized in non-uniform spatial distribution, so that geometric residuals of points in the point cloud are large, which may result in inefficient geometry coding and decoding of the point cloud.

Concepts of some embodiments are first described herein.

Point cloud. The point cloud may be a set of randomly distributed discrete points in space that represent a spatial structure and a surface attribute of a three-dimensional object or a three-dimensional scene. Point clouds may be classified into different categories according to different classification criteria, for example, classified into a dense point cloud and a sparse point cloud according to obtaining manners of the point clouds, or for another example, classified into a static point cloud and a dynamic point cloud according to timing types of the point clouds.

Point cloud data. Geometry information and attribute information of each point in a point cloud may jointly constitute the point cloud data. The geometry information may be referred to as three-dimensional position information. Geometry information of a point in the point cloud may be spatial coordinates (x, y, z) of the point, including coordinate values of the point in directions of coordinate axes of a three-dimensional coordinate system, for example, a coordinate value x in an X-axis direction, a coordinate value y in a Y-axis direction, and a coordinate value z in a Z-axis direction. Attribute information of a point in the point cloud may include at least one of color information, material information, and laser reflection intensity information (also referred to as reflectivity). Each point in the point cloud may have the same number of types of attribute information. For example, each point in the point cloud may have two types of attribute information, for example, color information and laser reflection intensity. For another example, each point in the point cloud may have three types of attribute information, for example, color information, material information, and laser reflection intensity information.

PCC. PCC is a process of coding geometry information and attribute information of each point in a point cloud to obtain a compressed bitstream. PCC may include two processes, for example, geometry information coding and attribute information coding. For different types of point clouds, PCC technologies may be classified into PCC based on geometry and PCC based on projection. Herein, geometry-based PCC (G-PCC) in a moving picture expert group (MPEG) standard and a PCC standard in an audio video coding standard (AVS) (AVS-PCC) are used as examples for description.

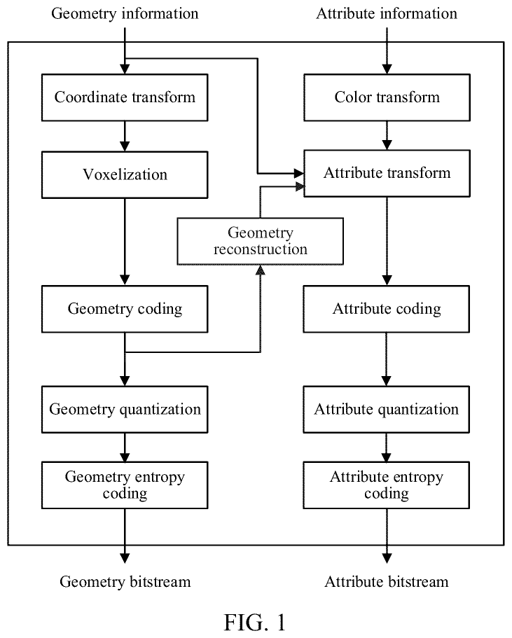

Coding frameworks of G-PCC and AVS-PCC may be similar, including a geometry information coding process and an attribute information coding process, as shown in FIG. 1. In the geometry information coding process, the geometry information of each point in the point cloud may be coded to obtain a geometry bitstream. In the attribute information coding process, the attribute information of each point in the point cloud may be coded to obtain an attribute bitstream. The geometry bitstream and the attribute bitstream may jointly constitute the compressed bitstream of the point cloud.

For the geometry information coding process, operations and processing are described as follows:

Preprocessing: including coordinate transform and voxelization. Through scaling and translation operations, point cloud data in a three-dimensional space may be converted to an integer form, and its minimum geometric position may be moved to an origin of coordinates.

Geometry coding: including two schemes, for example, octree-based geometry coding and trisoup-based geometry coding, which may be used under different conditions. Octree-based geometry coding: An octree is a tree-shaped data structure. A preset bounding box may be uniformly divided during three-dimensional space division, each node having eight child nodes. Whether each child node of the octree is occupied may be indicated by using “1” and “0”, to obtain occupancy code information as the bitstream of the geometry information of the point cloud.

Trisoup-based geometry coding: The point cloud may be divided into blocks of a predefined size, intersections of a surface of the point cloud at edges of the blocks are positioned, and triangles may be constructed. The geometry information may be compressed by coding intersection positions.

Geometry quantization: Fineness of the quantization may be determined by a quantization parameter (QP). A larger value of the QP indicates that coefficients within a larger value range are quantized to the same output, which may result in more distortion and a lower code rate. Conversely, a smaller value of the QP indicates that coefficients within a smaller value range are quantized to the same output, which may result in less distortion and a higher code rate.

Geometry entropy coding: Statistical compression coding is performed on the occupancy code information of the octree, and finally, a binary (0 or 1) compressed bitstream is outputted. Statistical coding is a lossless coding scheme, which may reduce a code rate to represent the same signal. A common statistical coding scheme is content adaptive binary arithmetic coding (CABAC).

For the attribute information coding process, operations and processing are described as follows:

Attribute recoloring: For lossy coding, based on coding the geometry information, the coder side may decode and reconstruct the geometry information, for example, restore the geometry information of each point in the point cloud, and search the original point cloud for attribute information of one or more neighboring points as attribute information of a reconstructed point.

Attribute transform coding: including three schemes, for example, predicting transform coding, lifting transform coding, and region adaptive hierarchical transform (RAHT) coding, which are used under different conditions.

Predicting transform coding: A subset of points are selected according to distances, and the point cloud is divided into a plurality of different levels of detail (LoDs), to implement coarse-to-fine point cloud representation. Bottom-up prediction is implemented between LoD neighbors. Attribute information of a point introduced into a fine LoD may be predicted from a neighboring point at a coarse LoD, to obtain a residual signal. A point at a bottommost LoD is coded as reference information.

Lifting transform coding: A weight update policy of a neighborhood point is introduced based on LoD neighbor prediction, to finally obtain a predicted attribute value of each point, and obtain a residual signal.

RAHT coding: The attribute information is subjected to RAHT to convert a signal to a transform domain, referred to as a transform coefficient.

Attribute quantization: Fineness of the quantization may be determined by a QP. In predicting transform coding and lifting transform coding, entropy coding is performed on a quantized residual value. In RAHT coding, entropy coding is performed on a quantized transform coefficient.

Attribute entropy coding: For a quantized attribute residual signal or transform coefficient, run length coding and arithmetic coding may be used for final compression. For a corresponding coding scheme, information such as a QP is also coded by using an entropy coder.

Point cloud decoding. Point cloud decoding is a process of decoding a compressed bitstream obtained by coding a point cloud to reconstruct the point cloud, and may be a process of reconstructing geometry information and attribute information of each point in the point cloud based on a geometry bitstream and an attribute bitstream in the compressed bitstream. Based on obtaining the compressed bitstream, for the geometry bitstream, the decoder side first performs entropy decoding to obtain quantized geometry information of each point in the point cloud, and performs inverse quantization to reconstruct the geometry information of each point in the point cloud. For the attribute bitstream, entropy decoding is first performed to obtain quantized prediction residual information or a quantized transform coefficient of each point in the point cloud. Inverse quantization is performed on the quantized prediction residual information to obtain reconstructed residual information, or inverse quantization is performed on the quantized transform coefficient to obtain a reconstructed transform coefficient, and inverse transform is performed on the reconstructed transform coefficient to obtain reconstructed residual information. The attribute information of each point in the point cloud is reconstructed based on the reconstructed residual information of each point in the point cloud. Reconstructed attribute information of each point in the point cloud is sequentially put in one-to-one correspondence with reconstructed geometry information to reconstruct the point cloud.

The concepts of some embodiments are described above, and technologies of some embodiments are described below.

### Preprocessing:

Floating point type coordinates of each point in an input point cloud are represented as (x^{m}, y^{m}, z^{m}), m=0, . . . , M−1, M being the number of points in the point cloud. A coordinate point (x^{min}, y^{min}, z^{min}) and a coordinate point (x^{max}, y^{max}, z^{max}) are represented as follows:

$${x}^{min} = min ( {x}^{0} , {x}^{1} , … , {x}^{M - 1} )$$

$${y}^{min} = min ( {y}^{0} , {y}^{1} , … , {y}^{M - 1} )$$

$${𝓏}^{min} = min ( {𝓏}^{0} , {𝓏}^{1} , … , {𝓏}^{M - 1} )$$

$${x}^{max} = max ( {x}^{0} , {x}^{1} , … , {x}^{M - 1} )$$

$${y}^{max} = max ( {y}^{0} , {y}^{1} , … , {y}^{M - 1} )$$

$${𝓏}^{max} = max ( {𝓏}^{0} , {𝓏}^{1} , … , {𝓏}^{M - 1} )$$

where the function min(s⁰, s¹, . . . , s^{M-1}) represents taking a minimum value of the current input, and max(s⁰, s¹, . . . , s^{M-1}) represents taking a maximum value of the current input.

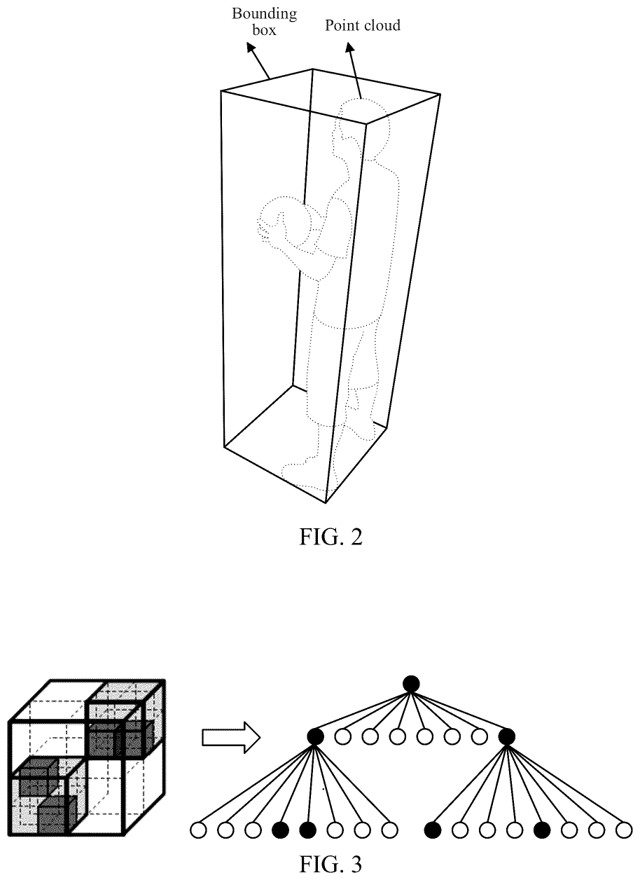

As shown in FIG. 2, a bounding box represents a largest cuboid that can contain all the points in the input point cloud. Origin coordinates (x^{origin}, y^{origin}, z^{origin}) of the bounding box are calculated according to the following formulas:

x^{origin}=int(floor(x^{min}))

y^{origin}=int(floor(y^{min}))

z^{origin}=int(floor(z^{min})) and
sizes of the bounding box in an x-direction, a y-direction, and a z-direction are calculated according to the following formulas:

$${BoudingBoxSize}_{x} = int ( {x}^{max} - {x}^{origin} ) + 1$$

$${BoudingBoxSize}_{y} = int ( {y}^{max} - {y}^{origin} ) + 1$$

$${BoudingBoxSize}_{𝓏} = int ( {𝓏}^{max} - {𝓏}^{origin} ) + 1$$

where int(s) is a rounding function, and the function floor(s) returns a largest integer value less than or equal to s.

### Octree Coding:

An octree is a tree-shaped data structure. Currently, the octree may be used to divide a point cloud in G-PCC or AVS-PCC. For point cloud data in a three-dimensional space, octree division is uniformly dividing a preset bounding box level by level, each node having eight child nodes. Whether each child node of the octree is occupied is indicated by using “1” and “0”, as shown in FIG. 3, to obtain occupancy code information as a bitstream of geometry information of the point cloud.

The octree is constructed based on a Morton order. Three-dimensional coordinate information of the point cloud data may be converted into a Morton code by querying a Morton order table. Nodes of each level of octree are obtained according to sorting of each Morton code. PCC technology may represent point cloud data by using octree partition, and may perform different processing procedures for geometry information and attribute information.

### Traveling Salesman Problem (TSP):

The TSP is a combinatorial optimization problem. The TSP may be described as follows: how to select a travel route to minimize a total journey if a merchandise salesman is going to several cities to market merchandise and the merchandise salesman needs to travel through all the cities after starting from a city and returns to the place of departure. From a perspective of a graph theory, the problem may be finding a loop with a least weight in a weighted undirected graph. Because a solution to the problem may be a full permutation of all vertices, as the number of vertices increases, a combinatorial explosion may occur, which is a non-deterministic polynomial (NP) complete problem. Methods for resolving the TSP may include a branch delimitation method, a linear programming method, a dynamic programming method, and the like. However, as the problem increases in scale, such algorithms may become impractical. Approximation algorithms or heuristic algorithms, including a genetic algorithm, a simulated annealing method, an ant colony algorithm, a contraindication search algorithm, a greedy algorithm, and a neural network algorithm, may also be used.

For example, if the TSP is modeled by using a weighted undirected graph, the cities are vertices of the graph, roads are edges of the graph, and lengths of the roads are lengths of the edges. the problem is a minimization problem where both start and end points are a vertex, and each vertex is visited once. The model may be a complete graph (for example, each pair of vertices are connected by one edge). If there is no path between two cities, adding a long edge can complete the graph without affecting computation of a loop.

In a symmetric TSP, back and forth distances between two cities are equal, leading to an undirected graph. The symmetry reduces the number of solutions by half. In an asymmetric TSP, a bidirectional path may not exist, or back and forth distances are different, leading to a directed graph. A traffic accident, a one-way road, and differences in ticket prices for departures and arrivals of cities are examples breaking the symmetry.

### Predictive Coding Technology:

A prediction relationship between signals is generated by using the TSP. All the points in the point cloud are connected into a single prediction tree, each point being predicted based on a signal value of its previous point. The method, for point cloud signal prediction, may be configured to act on whole original point cloud data, which can also act on a child node of the octree or a point cloud data subset obtained in another manner.

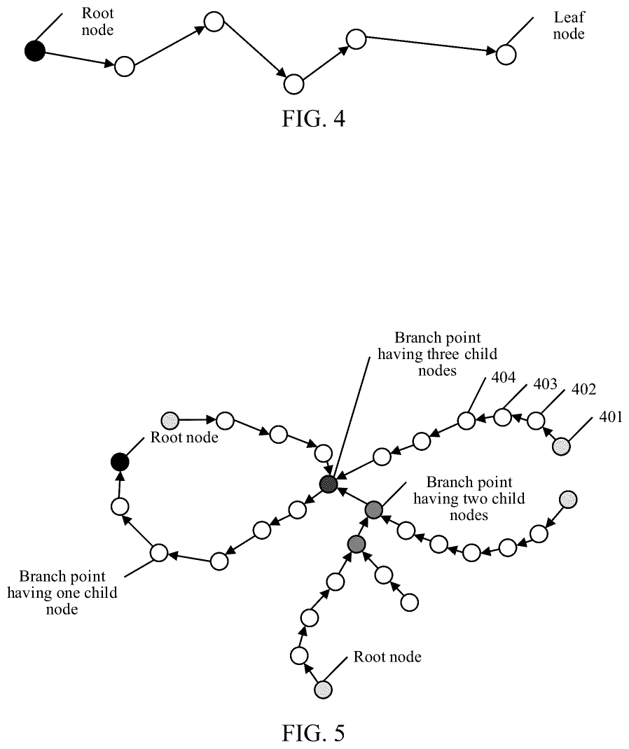

In addition, in a predictive coding technology in G-PCC, inter-point distance search is used to build a prediction tree. FIG. 4 shows a prediction tree coding structure in the AVS. The prediction tree shown in FIG. 4 is a single-chain prediction tree. FIG. 5 shows a prediction tree coding structure in the MPEG. The prediction tree shown in FIG. 5 is a multi-chain prediction tree. Each point is connected to another point and indicates the number of points connected to the point and one of four prediction modes. The four prediction modes are as follows:

### No Prediction.

Prediction using a parent point (a first-generation parent node), for example, a previous point. For example, for a point 401 in FIG. 5, a point 402 is its parent point.

Prediction using a parent point (a first-generation parent node) and a grandparent point (a second-generation parent node). For example, for a point 401 in FIG. 5, a point 402 is its parent point, and a point 403 is its grandparent point.

Prediction using a parent point (a first-generation parent node), a grandparent point (a second-generation parent node), and a grand-grandparent point (a third-generation parent node). For example, for a point 401 in FIG. 5, a point 402 is its parent point, a point 403 is its grandparent point, and a point 404 is its grand-grandparent point.

### Entropy Coding Technology:

The entropy coding technology may be configured for binarizing and processing a quantized (in a lossy case) signed prediction residual or transform coefficient.

Variable-length coding: Codewords of different lengths are used to represent residuals or coefficients that are to be coded. A code length may be designed according to an occurrence probability of a sign. Common methods include exponential-Golomb coding (exp-Golomb) and arithmetic coding.

### CABAC: Including the Following Several Operations:

Binarization: CABAC uses binary arithmetic coding, which means that two digits (1 or 0) are coded. A non-binary numerical sign, such as a transform coefficient or a motion vector, is first binarized or converted into a binary codeword before arithmetic coding. This process is similar to converting a value into a variable-length codeword, but the binary codeword is further coded by an arithmetic coder before transmitted.

Context model selection: A context model is a probability model, and the model is a model selected based on statistics of recently coded data signs. This model stores a probability of each “bin” being 1 or 0.

Arithmetic coding: The arithmetic coder codes each “bin” according to the selected probability model.

Probability update: The selected context model may be updated based on a coded value. For example, if a value of a “bin” is 1, a frequency count of 1 is increased.

Based on related descriptions of the concepts and the technologies, some embodiments provide a point cloud processing solution for improving geometry coding and decoding efficiency of a point cloud. In a point cloud coding stage of the point cloud processing solution, when a to-be-coded point in the point cloud may be coded, coding data is set, a coding scheme of the to-be-coded point in each direction is determined based on the coding data, and the to-be-coded point is coded based on the determined coding scheme. In the point cloud coding stage, a proper coding scheme is determined for each direction of the to-be-coded point for coding by using the coding data, so that geometry coding efficiency of the point cloud can be improved. In a point cloud decoding stage of the point cloud processing solution, when a to-be-decoded point in the point cloud may be decoded, coding data is obtained, a coding scheme of the to-be-decoded point in each direction is determined based on the coding data, and the to-be-decoded point is decoded based on the determined coding scheme. In the point cloud decoding stage, a proper coding scheme is determined for each direction of the to-be-decoded point for decoding by using the coding data, so that geometry decoding efficiency of the point cloud can be improved.

The point cloud processing solution provided in some embodiments may be further combined with technologies such as cloud computing and cloud storage in cloud technologies. Cloud computing is a computing mode, which distributes computing tasks in a resource pool including a large number of computers, so that various application systems may obtain computing power, storage spaces, and information services. Cloud computing provides powerful computing support for the point cloud coding stage and the point cloud decoding stage, to greatly improve geometry coding efficiency and geometry decoding efficiency of a point cloud. A distributed cloud storage system (or a “storage system”) is a storage system in which a large number of different types of storage devices (which may also be referred to as storage nodes) in a network are integrated through application software or an application interface by using functions such as a cluster application, a grid technology, and a distributed storage file system, and cooperate to jointly provide data storage and service access functions to the outside. Cloud storage provides powerful storage support for the point cloud coding stage and the point cloud decoding stage, which can further improve the geometry coding efficiency and the geometry decoding efficiency of the point cloud.

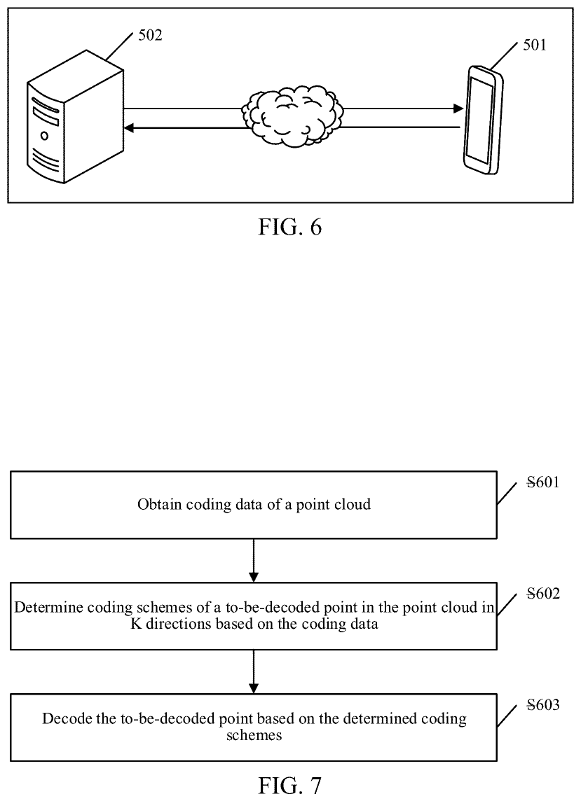

A point cloud processing system adapted to implement the point cloud processing solution provided in some embodiments are described below with reference to FIG. 6. As shown in FIG. 6, the point cloud processing system includes a coding device 501 and a decoding device 502. The coding device 501 is a terminal or a server, the decoding device 502 is a terminal or a server, and a direct or indirect communication connection is established between the coding device 501 and the decoding device 502 through wired communication or wireless communication. The terminal includes but is not limited to a smartphone, a tablet computer, a notebook computer, a desktop computer, a smart voice interaction device, a smart watch, a vehicle-mounted terminal, a smart home appliance, an aircraft, or the like. The server includes an independent physical server, a server cluster or a distributed system including a plurality of physical servers, or a cloud server providing cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

### Coding Device 501:

The coding device 501 obtains point cloud data (for example, geometry information and attribute information of each point in a point cloud). The point cloud data is obtained through scene capture or in a device-generated manner. Obtaining point cloud data through scene capture is obtaining point cloud data by capturing a visual scene of the real world by using a capture device associated with the coding device 501. The capture device may be configured to provide a point cloud data obtaining service for the coding device 501. The capture device includes but is not limited to any one of a camera device, a sensing device, and a scanning device. The camera device includes a camera, a stereo camera, a light field camera, and the like. The sensing device includes a laser device, a radar device, and the like. The scanning device includes a three-dimensional laser scanning device and the like. The capture device associated with the coding device 501 is a hardware component disposed in the coding device 501. For example, the capture device is a camera or a sensor of the terminal. The capture device associated with the coding device 501 may be a hardware device connected to the coding device 501, for example, a camera connected to the server. Obtaining point cloud data in a device-generated manner means that the coding device 501 generates point cloud data based on a virtual object (such as a virtual three-dimensional object or a virtual three-dimensional scene obtained through three-dimensional modeling).

The coding device 501 may be configured to code the geometry information of each point in the point cloud to obtain a geometry bitstream, and code the attribute information of each point in the point cloud to obtain an attribute bitstream. In some embodiments, a geometry coding process of the coding device 501 is directed to geometric residual information of a to-be-coded point in the point cloud. The geometric residual information includes a signed residual value of the to-be-coded point in each direction (for example, an x-direction, a y-direction, and a z-direction). In some embodiments, a coding process of the signed residual value is divided into a coding process of an unsigned residual value (for example, an absolute value of the signed residual value, or a “residual value”) and a coding process of residual sign information. For the coding process of the unsigned residual value, the coding device 501 determines a proper coding scheme for the to-be-coded point in each direction, and codes an unsigned residual value of the to-be-coded point in each direction based on the determined coding scheme. The geometry bitstream obtained by the coding device 501 through coding includes coding of the unsigned residual value of the to-be-coded point in each direction, and coding of residual sign information of the to-be-coded point in each direction. The coding device 501 transmits, to the decoding device 502, the geometry bitstream and the attribute bitstream that are obtained through coding.

### Decoding Device 502:

Based on receiving a compressed bitstream (including the attribute bitstream and the geometry bitstream) transmitted from the coding device 201, the decoding device 502 decodes the geometry bitstream to reconstruct the geometry information of each point in the point cloud, and decodes the attribute bitstream to reconstruct the attribute information of each point in the point cloud. In some embodiments, a geometry decoding process of the decoding device 502 is directed to geometric residual coding of a to-be-decoded point in the point cloud in each direction (for example, the x-direction, the y-direction, and the z-direction). The geometric residual coding includes residual value coding of the to-be-decoded point in each direction and residual sign coding of the to-be-decoded point in each direction. For the residual value coding of the to-be-decoded point in each direction, the decoding device 502 determines a proper coding scheme for the to-be-decoded point in each direction, and performs residual value decoding for the to-be-decoded point in each direction based on the determined coding scheme, to reconstruct an unsigned residual value of the to-be-decoded point in each direction. For the residual sign coding of the to-be-decoded point in each direction, the decoding device 502 performs decoding to obtain residual sign information of the to-be-decoded point in each direction, based on which the decoding device 502 reconstructs a signed residual value of the to-be-decoded point in each direction, for example, reconstructed residual information of the to-be-decoded point, to reconstruct geometry information of the to-be-decoded point. The decoding device 202 puts reconstructed geometry information and attribute information of each point in the point cloud in one-to-one correspondence, to reconstruct the point cloud.

In some embodiments, the coding device determines a proper coding scheme for the to-be-coded point in the point cloud in each direction for coding, which may improve geometry coding efficiency of the point cloud. The decoding device determines a proper coding scheme for the to-be-decoded point in the point cloud in each direction for decoding, which may improve geometry decoding efficiency of the point cloud. The point cloud system described in some embodiments are intended to more clearly describe the technical solutions of some embodiments, and does not constitute any limitation on the technical solutions provided in some embodiments. A person of ordinary skill in the art may be aware that, with evolution of system architectures and emergence of new service scenarios, the technical solutions provided in some embodiments are also applicable to similar technical problems.

The following describes the point cloud processing solution according to some embodiments with reference to accompanying drawings.

Some embodiments provide a point cloud processing method. The point cloud processing method describes content that a decoder side determines a proper coding scheme for a to-be-decoded point in a point cloud in each direction, and performs decoding based on the determined coding scheme. The point cloud processing method is performed by a computer device. For example, the computer device is the decoding device 502 in the point cloud processing system. As shown in FIG. 7, the point cloud processing method includes 601 to 603:

601: Obtain coding data of a point cloud.

602: Determine coding schemes of a to-be-decoded point in the point cloud in K directions based on the coding data.

In 601 and 602, in a parsing process of a point cloud, coding data of the point cloud is obtained, and coding schemes of a to-be-decoded point in the point cloud in K directions are determined based on the coding data of the point cloud. In some embodiments, a same coding scheme is used for the to-be-decoded point in the K directions, or different coding schemes are used for the to-be-decoded point in the K directions, K being a positive integer.

When a same coding scheme is used for the to-be-decoded point in the K directions, the determining coding schemes of a to-be-decoded point in the point cloud in K directions based on the coding data includes but is not limited to any one of the following:

A coder side and a decoder side consider by default that a same coding scheme is used in all of the K directions. In some embodiments, the coding data includes default setting information, the default setting information being set by default by the decoder side and the coder side. In this case, based on the default setting information, it is determined that a default coding scheme is used for the to-be-decoded point in the K directions. If the default setting information indicates that the coding schemes in the K directions are the same, a same default coding scheme is used for the to-be-decoded point in all of the K directions. In some embodiments, the default setting information further indicates a default coding scheme. For example, the default setting information indicates that the coding schemes of the to-be-decoded point in the K directions are the same, and the same coding scheme is a first coding scheme, a second coding scheme, or a third coding scheme.

Scheme setting information is parsed out from a coding parameter set or a coded bitstream to determine the coding schemes. In some embodiments, the coding data includes scheme setting information, the scheme setting information being parsed out from a coding parameter set or a coded bitstream (for example, the geometry bitstream) of the point cloud. In this case, if the scheme setting information is common to the to-be-decoded point in the K directions, it is determined that a same coding scheme is used for the to-be-decoded point in the K directions, and a coding scheme common to the to-be-decoded point in the K directions is determined based on the scheme setting information common to the to-be-decoded point in the K directions.

The scheme setting information includes either or both of a residual division flag field (ptn_residual_divide_flag) and a number-of-occupied-bits division flag field (ptn_numbits_divide_flag). The determining a coding scheme common to the to-be-decoded point in the K directions based on the scheme setting information common to the to-be-decoded point in the K directions includes any one of the following cases:

When the scheme setting information includes the residual division flag field, and a value of the residual division flag field is a target value (for example, the target value is 1) (for example, when ptn_residual_divide_flag=1), it is determined that the coding scheme common to the to-be-decoded point in the K directions is the first coding scheme. When the value of the residual division flag field is a reference value (for example, the reference value is 0) (for example, when ptn_residual_divide_flag=0), it is determined that the coding scheme common to the to-be-decoded point in the K directions is a fourth coding scheme.

When the scheme setting information includes the number-of-occupied-bits division flag field, and a value of the number-of-occupied-bits division flag field is the target value (for example, when ptn_numbits_divide_flag=1), it is determined that the coding scheme common to the to-be-decoded point in the K directions is the second coding scheme. When the value of the number-of-occupied-bits division flag field is the reference value (for example, when ptn_numbits_divide_flag=0), it is determined that the coding scheme common to the to-be-decoded point in the K directions is the fourth coding scheme.

When the scheme setting information includes the residual division flag field and the number-of-occupied-bits division flag field, and values of the residual division flag field and the number-of-occupied-bits division flag field are both the target value (for example, when ptn_residual_divide_flag=1 and ptn_numbits_divide_flag=1), it is determined that the coding scheme common to the to-be-decoded point in the K directions is the third coding scheme. When the value of the residual division flag field is the target value and the value of the number-of-occupied-bits division flag field is the reference value (for example, when ptn_residual_divide_flag=1 and ptn_numbits_divide_flag=0), it is determined that the coding scheme common to the to-be-decoded point in the K directions is the first coding scheme. When the value of the residual division flag field is the reference value and the value of the number-of-occupied-bits division flag field is the target value (for example, when ptn_residual_divide_flag=0 and ptn_numbits_divide_flag=1), it is determined that the coding scheme common to the to-be-decoded point in the K directions is the second coding scheme. When the values of the residual division flag field and the number-of-occupied-bits division flag field are both the reference value (for example, when ptn_residual_divide_flag=0 and ptn_numbits_divide_flag=0), it is determined that the coding scheme common to the to-be-decoded point in the K directions is the fourth coding scheme.

A default decision threshold is set or a decision threshold is parsed out from the coded bitstream of the point cloud to decide the coding schemes. In some embodiments, the coding data includes a decision threshold, the decision threshold being set by default by the decoder side and the coder side, or the decision threshold being parsed out from the coded bitstream of the point cloud. In this case, scheme decision information is parsed out from the coded bitstream of the point cloud, and the coding schemes of the to-be-decoded point in the K directions are decided based on the scheme decision information and the decision threshold.

The decision threshold includes a coding parsing threshold, and the scheme decision information includes coding parsing information of the to-be-decoded point in the K directions. In this case, the deciding the coding schemes of the to-be-decoded point in the K directions based on the scheme decision information and the decision threshold includes: when a same coding scheme is used for the to-be-decoded point in the K directions, determining statistical characteristic information of the coding parsing information of the to-be-decoded point in the K directions, and determining a coding scheme common to the to-be-decoded point in the K directions based on a magnitude relationship between the statistical characteristic information and the coding parsing threshold. The statistical characteristic information includes any one of an average value of the coding parsing information of the to-be-decoded point in the K directions, a minimum value of the coding parsing information of the to-be-decoded point in the K directions, and a maximum value of the coding parsing information of the to-be-decoded point in the K directions.

In some embodiments, the coding parsing threshold includes a residual threshold (t1/2, t1>0), and the coding parsing information includes residual parsing information. Statistical characteristic information of residual parsing information of the to-be-decoded point in the K directions may be determined, and a coding scheme common to the to-be-decoded point in the K directions may be determined based on a magnitude relationship between the statistical characteristic information and the residual threshold. In some embodiments, when the statistical characteristic information is less than the residual threshold, it is determined that the coding scheme common to the to-be-decoded point in the K directions is the first coding scheme. When the statistical characteristic information is greater than or equal to the residual threshold, it is determined that the coding scheme common to the to-be-decoded point in the K directions is the fourth coding scheme.

In some embodiments, the coding parsing threshold includes a number-of-occupied-bits threshold (t2/2, t2>0), and the coding parsing information includes number-of-occupied-bits parsing information. Statistical characteristic information of number-of-occupied-bits parsing information of the to-be-decoded point in the K directions may be determined, and a coding scheme common to the to-be-decoded point in the K directions may be determined based on a magnitude relationship between the statistical characteristic information and the number-of-occupied-bits threshold. In some embodiments, when the statistical characteristic information is less than the number-of-occupied-bits threshold, it is determined that the coding scheme common to the to-be-decoded point in the K directions is the second coding scheme. When the statistical characteristic information is greater than or equal to the number-of-occupied-bits threshold, it is determined that the coding scheme common to the to-be-decoded point in the K directions is the fourth coding scheme.

The decision threshold includes a quantization threshold, the scheme decision information includes a QP common to the to-be-decoded point in the K directions, and a same coding scheme is used for the to-be-decoded point in the K directions. In this case, the deciding the coding schemes of the to-be-decoded point in the K directions based on the scheme decision information and the decision threshold includes: determining a coding scheme common to the to-be-decoded point in the K directions based on a magnitude relationship between the QP and the quantization threshold.

In some embodiments, the quantization threshold includes a first quantization threshold (t3, t3>0). If the QP is less than the first quantization threshold, it is determined that the coding scheme common to the to-be-decoded point in the K directions is any one of the first coding scheme, the second coding scheme, or the third coding scheme. If the QP is greater than or equal to the first quantization threshold, it is determined that the coding scheme common to the to-be-decoded point in the K directions is the fourth coding scheme.

In some embodiments, the quantization threshold includes a second quantization threshold (t4, t4>0). If the QP is greater than the second quantization threshold, it is determined that the coding scheme common to the to-be-decoded point in the K directions is any one of the first coding scheme, the second coding scheme, or the third coding scheme. If the QP is less than or equal to the second quantization threshold, it is determined that the coding scheme common to the to-be-decoded point in the K directions is the fourth coding scheme.

In some embodiments, the quantization threshold includes a first quantization threshold (t3, t3>0) and a second quantization threshold (t4, t4>0), the second quantization threshold being less than the first quantization threshold. If the QP is greater than the second quantization threshold and is less than the first quantization threshold, it is determined that the coding scheme common to the to-be-decoded point in the K directions is any one of the first coding scheme, the second coding scheme, or the third coding scheme. If the QP is greater than or equal to the first quantization threshold or is less than or equal to the second quantization threshold, it is determined that the coding scheme common to the to-be-decoded point in the K directions is the fourth coding scheme.

The decision threshold includes a bounding box threshold (t5), the scheme decision information includes a bounding box size of a prediction tree of the point cloud, and the bounding box size includes sizes in the K directions. In this case, the deciding the coding schemes of the to-be-decoded point in the K directions based on the scheme decision information and the decision threshold includes: when a same coding scheme is used for the to-be-decoded point in the K directions, determining a target size feature value based on the sizes in the K directions, and determining a coding scheme common to the to-be-decoded point in the K directions based on a magnitude relationship between the target size feature value and the bounding box threshold. The target size feature value is a ratio between sizes in any two of the K directions. For example, the bounding box size includes sizes in three directions: an x-direction size BoundingBoxSizeₓ, a y-direction size BoundingBoxSize_{y}, and a z-direction size BoundingBoxSize_{z}, and the target size feature value is a ratio (BoundingBoxSizeₓ/BoundingBoxSize_{z}) between the x-direction size BoundingBoxSizeₓ and the z-direction size BoundingBoxSize_{z}.

When different coding schemes are used for the to-be-decoded point in the K directions, the determining coding schemes of a to-be-decoded point in the point cloud in K directions based on the coding data of the point cloud includes but is not limited to any one of the following:

The coder side and the decoder side consider by default that different coding schemes are used in the K directions. In some embodiments, the coding data includes default setting information, the default setting information being set by default by the decoder side and the coder side. In this case, based on the default setting information, it is determined that a default coding scheme is used for the to-be-decoded point in the K directions. If the default setting information indicates that the coding schemes in the K directions are different, different default coding schemes are used for the to-be-decoded point in different directions of the K directions. In some embodiments, the default setting information further indicates a default coding scheme. For example, the default setting information indicates that the coding schemes in the K directions (for example, the x-direction, the y-direction, and the z-direction) are different, and a coding scheme of the to-be-decoded point in the x-direction is the first coding scheme, a coding scheme of the to-be-decoded point in the y-direction is the second coding scheme, and a coding scheme of the to-be-decoded point in the z-direction is the third coding scheme.

Scheme setting information is parsed out from the coding parameter set or the coded bitstream to determine the coding schemes. In some embodiments, the coding data includes scheme setting information, the scheme setting information being parsed out from the coding parameter set or the coded bitstream (for example, the geometry bitstream) of the point cloud. In this case, if the to-be-decoded point has one piece of scheme setting information in each of the K directions, it is determined that different coding schemes are used for the to-be-decoded point in the K directions, and a coding scheme of the to-be-decoded point in each direction is determined based on the scheme setting information of the to-be-decoded point in each direction.

A k^{th} direction of the K directions is used as an example. Scheme setting information of the to-be-decoded point in the k^{th} direction includes either or both of a residual division flag field (ptn_residual_divide_flag[k]) and a number-of-occupied-bits division flag field (ptn_numbits_divide_flag[k]), k being a positive integer less than or equal to K. The determining a coding scheme of the to-be-decoded point in each direction based on the scheme setting information of the to-be-decoded point in each direction includes:

When the scheme setting information includes the residual division flag field, and a value of the residual division flag field of the to-be-decoded point in the k^{th} direction is a target value (for example, the target value is 1) (for example, when ptn_residual_divide_flag[k]=1), it is determined that a coding scheme of the to-be-decoded point in the k^{th} direction is the first coding scheme. When the value of the residual division flag field of the to-be-decoded point in the k^{th} direction is a reference value (for example, the reference value is 0) (for example, when ptn_residual_divide_flag[k]=0), it is determined that the coding scheme of the to-be-decoded point in the k^{th} direction is the fourth coding scheme.

When the scheme setting information includes the number-of-occupied-bits division flag field, and a value of the number-of-occupied-bits division flag field of the to-be-decoded point in the k^{th} direction is the target value (for example, when ptn_numbits_divide_flag[k]=1), it is determined that the coding scheme of the to-be-decoded point in the k^{th} direction is the second coding scheme. When the value of the number-of-occupied-bits division flag field of the to-be-decoded point in the k^{th} direction is the reference value (for example, when ptn_numbits_divide_flag[k]=0), it is determined that the coding scheme of the to-be-decoded point in the k^{th} direction is the fourth coding scheme.

When the scheme setting information includes the residual division flag field and the number-of-occupied-bits division flag field, and values of the residual division flag field and the number-of-occupied-bits division flag field of the to-be-decoded point in the k^{th} direction are both the target value (for example, when ptn_residual_divide_flag[k]=1 and ptn_numbits_divide_flag[k]=1), it is determined that the coding scheme of the to-be-decoded point in the k^{th} direction is the third coding scheme. When the value of the residual division flag field of the to-be-decoded point in the k^{th} direction is the target value and the value of the number-of-occupied-bits division flag field of the to-be-decoded point in the k^{th} direction is the reference value (for example, when ptn_residual_divide_flag[k]=1 and ptn_numbits_divide_flag[k]=0), it is determined that the coding scheme of the to-be-decoded point in the k^{th} direction is the first coding scheme. When the value of the residual division flag field of the to-be-decoded point in the k^{th} direction is the reference value and the value of the number-of-occupied-bits division flag field of the to-be-decoded point in the k^{th} direction is the target value (for example, when ptn_residual_divide_flag[k]=0 and ptn_numbits_divide_flag[k]=1), it is determined that the coding scheme of the to-be-decoded point in the k^{th} direction is the second coding scheme. When the values of the residual division flag field and the number-of-occupied-bits division flag field of the to-be-decoded point in the k^{th} direction are both the reference value (for example, when ptn_residual_divide_flag[k]=0 and ptn_numbits_divide_flag[k]=0), it is determined that the coding scheme of the to-be-decoded point in the k^{th} direction is the fourth coding scheme.

A default decision threshold is set or a decision threshold is parsed out from the coded bitstream of the point cloud to decide the coding schemes. In some embodiments, the coding data includes a decision threshold, the decision threshold being set by default by the decoder side and the coder side, or the decision threshold being parsed out from the coded bitstream of the point cloud. In this case, scheme decision information is parsed out from the coded bitstream of the point cloud, and the coding schemes of the to-be-decoded point in the K directions are decided based on the scheme decision information and the decision threshold.

The decision threshold includes a coding parsing threshold, and the scheme decision information includes coding parsing information of the to-be-decoded point in the K directions. In this case, the deciding the coding schemes of the to-be-decoded point in the K directions based on the scheme decision information and the decision threshold includes: when different coding schemes are used for the to-be-decoded point in the K directions, determining a coding scheme of the to-be-decoded point in each direction based on a magnitude relationship between the coding parsing threshold and coding parsing information of the to-be-decoded point in each direction.

In some embodiments, the coding parsing threshold includes a residual threshold (t1/2, t1>0). The k^{th} direction of the K directions is used as an example. Coding parsing information of the to-be-decoded point in the k^{th} direction includes residual parsing information. A coding scheme of the to-be-decoded point in the k^{th} direction may be determined based on a magnitude relationship between the residual threshold and the residual parsing information of the to-be-decoded point in the k^{th} direction. In some embodiments, when the residual parsing information of the to-be-decoded point in the k^{th} direction is less than the residual threshold, it is determined that the coding scheme of the to-be-decoded point in the k^{th} direction is the first coding scheme. When the residual parsing information of the to-be-decoded point in the k^{th} direction is greater than or equal to the residual threshold, it is determined that the coding scheme of the to-be-decoded point in the k^{th} direction is the fourth coding scheme.

In some embodiments, the coding parsing threshold includes a number-of-occupied-bits threshold (t2/2, t2>0). The k^{th} direction of the K directions is used as an example. Coding parsing information of the to-be-decoded point in the k^{th} direction includes number-of-occupied-bits parsing information. A coding scheme of the to-be-decoded point in the k^{th} direction may be determined based on a magnitude relationship between the number-of-occupied-bits threshold and the number-of-occupied-bits parsing information of the to-be-decoded point in the k^{th} direction. In some embodiments, when the number-of-occupied-bits parsing information of the to-be-decoded point in the k^{th} direction is less than the number-of-occupied-bits threshold, it is determined that the coding scheme of the to-be-decoded point in the k^{th} direction is the second coding scheme. When the number-of-occupied-bits parsing information of the to-be-decoded point in the k^{th} direction is greater than or equal to the number-of-occupied-bits threshold, it is determined that the coding scheme of the to-be-decoded point in the k^{th} direction is the fourth coding scheme.

The decision threshold includes a bounding box threshold (t5), the scheme decision information includes a bounding box size of a prediction tree of the point cloud, and the bounding box size includes sizes in the K directions. In this case, the deciding the coding schemes of the to-be-decoded point in the K directions based on the scheme decision information and the decision threshold includes: when different coding schemes are used for the to-be-decoded point in the K directions, determining a size feature value of each of the K directions based on the sizes in the K directions, and determining a coding scheme of the to-be-decoded point in a corresponding direction based on a magnitude relationship between the bounding box threshold and the size feature value of each direction. A size feature value of the k^{th} direction is a ratio between a size in the k^{th} direction and a size in another direction (any direction in the K directions except the k^{th} direction). For example, the bounding box size includes sizes in three directions: an x-direction size BoundingBoxSizeₓ, a y-direction size BoundingBoxSize_{y}, and a z-direction size BoundingBoxSize_{z}, and a size feature value of the x-direction is a ratio (BoundingBoxSizeₓ/BoundingBoxSize_{z}) between the x-direction size BoundingBoxSizeₓ and the z-direction size BoundingBoxSize_{z}.

603: Decode the to-be-decoded point based on the determined coding schemes.

Based on the coding schemes of the to-be-decoded point in the K directions being determined, the to-be-decoded point may be decoded based on the determined coding schemes. In some embodiments, the decoding the to-be-decoded point based on the determined coding schemes includes: performing residual value decoding for the to-be-decoded point based on the determined coding schemes, to obtain reconstructed residual values of the to-be-decoded point in the K directions; performing residual sign decoding for the to-be-decoded point, to obtain reconstructed residual sign information of the to-be-decoded point in the K directions; determining reconstructed residual information of the to-be-decoded point based on the reconstructed residual values of the to-be-decoded point in the K directions and the reconstructed residual sign information of the to-be-decoded point in the K directions; and reconstructing geometry information of the to-be-decoded point based on the reconstructed residual information of the to-be-decoded point.

The reconstructed residual values, obtained by performing residual value decoding for the to-be-decoded point based on the determined coding schemes, of the to-be-decoded point in the K directions may be reconstructed unsigned residual values (for example, absolute values of residual values), residual sign decoding further may be performed for the to-be-decoded point to obtain the reconstructed residual sign information of the to-be-decoded point in the K directions, and residual information of the to-be-decoded point may be reconstructed based on the reconstructed residual values of the to-be-decoded point in the K directions and the reconstructed residual sign information of the to-be-decoded point in the K directions. For example, reconstructed residual values of the to-be-decoded point in the x-direction, the y-direction, and the z-direction constitute coordinates (2, 5, 3), reconstructed residual sign information of the to-be-decoded point in the x-direction indicates that a residual value of the to-be-decoded point in the x-direction is a negative number, reconstructed residual sign information of the to-be-decoded point in the y-direction indicates that a residual value of the to-be-decoded point in the y-direction is a negative number, and reconstructed residual sign information of the to-be-decoded point in the z-direction indicates that a residual value of the to-be-decoded point in the z-direction is a negative number. In this case, the reconstructed residual information of the to-be-decoded point is (−2, −5, −3).

The k^{th} direction of the K directions is used as an example herein to describe residual value decoding processes in different coding schemes:

When the coding scheme of the to-be-decoded point in the k^{th} direction is the first coding scheme, the first coding scheme being a coding scheme of coding a residual value of the to-be-decoded point in the k^{th} direction after-remainder calculation, a residual value decoding process in the first coding scheme includes as follows: parsing a number-of-occupied-bits field of the to-be-decoded point in the k^{th} direction (for example, ptn_residual_numbits[k]), to obtain a number B[k] of occupied bits of a residual quotient A1[k] of the to-be-decoded point in the k^{th} direction; parsing B[k] bit values in a bit value field of the to-be-decoded point in the k^{th} direction (for example, B[k] bit values of ptn_residual_value_per[k]), to obtain the residual quotient A1[k]; parsing a residual remainder field of the to-be-decoded point in the k^{th} direction (for example, ptn_residual_abs_remaining[k]), to obtain a residual remainder A2[k] of the to-be-decoded point in the k^{th} direction; and determining a reconstructed residual value A[k](A[k]=A1[k]×d+A2[k]) of the to-be-decoded point in the k^{th} direction based on the residual quotient A1[k] and the residual remainder A2[k], d representing a divisor in-remainder calculation, for example, if the remainder calculation is performing division by 2 and obtaining a remainder, d=2.

When the coding scheme of the to-be-decoded point in the k^{th} direction is the second coding scheme, the second coding scheme being a coding scheme of coding a number of occupied bits of the residual value of the to-be-decoded point in the k^{th} direction after-remainder calculation, a residual value decoding process in the second coding scheme includes as follows: parsing a number-of-occupied-bits field of the to-be-decoded point in the k^{th} direction (for example, ptn_residual_numbits[k]), to obtain a number-of-occupied-bits quotient B1[k] of the to-be-decoded point in the k^{th} direction; parsing a number-of-occupied-bits remainder field of the to-be-decoded point in the k^{th} direction (for example, ptn_numbits_remaining[k]), to obtain a number-of-occupied-bits remainder B2[k] of the to-be-decoded point in the k^{th} direction; determining a number B[k](B[k]=B1[k]×d+B2[k]) of occupied bits of a reconstructed residual value A[k] of the to-be-decoded point in the k^{th} direction based on the number-of-occupied-bits quotient B1[k] and the number-of-occupied-bits remainder B2[k]; and parsing B[k] bit values in a bit value field of the to-be-decoded point in the k^{th} direction (for example, B[k] bit values of ptn_residual_value_per[k]), to obtain the reconstructed residual value A[k] of the to-be-decoded point in the k^{th} direction, d representing a divisor in-remainder calculation, for example, if the remainder calculation is performing division by 2 and obtaining a remainder, d=2.

When the coding scheme of the to-be-decoded point in the k^{th} direction is the third coding scheme, the third coding scheme being a coding scheme of performing remainder calculation on the residual value of the to-be-decoded point in the k^{th} direction, performing remainder calculation on a number of occupied bits of a remainder calculation result, and performing coding, a residual value decoding process in the third coding scheme includes as follows: parsing a number-of-occupied-bits field of the to-be-decoded point in the k^{th} direction (for example, ptn_residual_numbits[k]), to obtain a number-of-occupied-bits quotient B1[k] of the to-be-decoded point in the k^{th} direction; parsing a number-of-occupied-bits remainder field of the to-be-decoded point in the k^{th} direction (for example, ptn_numbits_remaining[k]), to obtain a number-of-occupied-bits remainder B2[k] of the to-be-decoded point in the k^{th} direction; determining a number B[k](B[k]=B1[k]×d+B2[k]) of occupied bits of a residual quotient A1[k] of the to-be-decoded point in the k^{th} direction based on the number-of-occupied-bits quotient B1[k] and the number-of-occupied-bits remainder B2[k]; parsing B[k] bit values in a bit value field of the to-be-decoded point in the k^{th} direction (for example, B[k] bit values of ptn_residual_value_per[k]), to obtain the residual quotient A1[k]; parsing a residual remainder field of the to-be-decoded point in the kai direction (for example, ptn_residual_abs_remaining[k]), to obtain a residual remainder A2[k] of the to-be-decoded point in the k^{th} direction; and determining a reconstructed residual value A[k](A[k]=A1[k]×d+A2[k]) of the to-be-decoded point in the k^{th} direction based on the residual quotient A1[k] and the residual remainder A2[k], d representing a divisor in-remainder calculation, for example, if the remainder calculation is performing division by 2 and obtaining a remainder, d=2.

When the coding scheme of the to-be-decoded point in the k^{th} direction is the fourth coding scheme, the fourth coding scheme being a coding scheme of directly coding the residual value of the to-be-decoded point in the k^{th} direction without remainder calculation, a residual value decoding process in the fourth coding scheme includes as follows: parsing a number-of-occupied-bits field of the to-be-decoded point in the k^{th} direction (for example, ptn_residual_numbits[k]), to obtain a number B[k] of occupied bits of the residual value A[k] of the to-be-decoded point in the k^{th} direction; and parsing B[k] bit values in a bit value field of the to-be-decoded point in the k^{th} direction (for example, B[k] bit values of ptn_residual_value_per[k]), to obtain the residual value A[k] of the to-be-decoded point in the k^{th} direction.

After the residual value decoding processes are described, residual sign decoding processes are described herein. The performing residual sign decoding for the to-be-decoded point, to obtain reconstructed residual sign information of the to-be-decoded point in the K directions includes any one of the following manners:

Sign information in the K directions is directly parsed. In some embodiments, residual sign coding of the to-be-decoded point in the K directions is read from the coded bitstream of the point cloud, and the residual sign coding of the to-be-decoded point in the K directions is parsed, to obtain the reconstructed residual sign information of the to-be-decoded point in the K directions.

A sign association relationship with a previous point (for example, a first-generation parent node in the predictive coding technology) is set by default or determined by parsing sign indication information. In some embodiments, sign indication information (signFlag) is obtained, the sign indication information being set by default by the coder side and the decoder side, or parsed out from the coding parameter set or the coded bitstream of the point cloud. In some embodiments, a sign association relationship between the to-be-decoded point and a previous point of the to-be-decoded point is determined based on a value of the sign indication information. For example, when the value of the sign indication information is a target value (for example, the target value is 1) (for example, when signFlag=1), it is determined that there is a sign association relationship between the to-be-decoded point and the previous point of the to-be-decoded point. When the value of the sign indication information is a reference value (for example, the reference value is 0) (for example, when signFlag=0), it is determined that there is no sign association relationship between the to-be-decoded point and the previous point of the to-be-decoded point. If there is a sign association relationship between the to-be-decoded point and the previous point of the to-be-decoded point, the reconstructed residual sign information of the to-be-decoded point in the K directions is determined based on reconstructed residual sign information of the previous point of the to-be-decoded point in the K directions. For example, the reconstructed residual sign information of the to-be-decoded point in the K directions is the same as the reconstructed residual sign information of the previous point of the to-be-decoded point in the K directions by direction correspondence, or reconstructed residual sign information of the to-be-decoded point in each of the K directions is the same as reconstructed residual sign information of the previous point in the same direction. If there is no sign association relationship between the to-be-decoded point and the previous point of the to-be-decoded point, the residual sign coding of the to-be-decoded point in the K directions is read from the coded bitstream of the point cloud, and the residual sign coding of the to-be-decoded point in the K directions is parsed, to obtain the reconstructed residual sign information of the to-be-decoded point in the K directions.

The parsing the residual sign coding of the to-be-decoded point in the K directions, to obtain the reconstructed residual sign information of the to-be-decoded point in the K directions includes any one of the following:

First: The residual sign coding of the to-be-decoded point in the K directions is directly parsed. In some embodiments, ptn_residual_sign_flag fields (for example, residual sign fields) respectively corresponding to the to-be-decoded point in the K directions are directly parsed.

Second: The residual sign coding of the to-be-decoded point in the K directions is parsed by using K2 context models. In some embodiments, ptn_residual_sign_flag (for example, residual sign fields) of the to-be-decoded point in the K directions is parsed by using K2 context models, K2 being a positive integer less than or equal to K.

Third: The coded bitstream of the to-be-decoded point is parsed based on the reconstructed residual values of the to-be-decoded point in the K directions and a distance between the previous point of the to-be-decoded point and a parent node of the previous point, to obtain residual sign information (for example, signs) of the to-be-decoded point in the K directions.

In some embodiments, for example, the to-be-decoded point is Pᵢ, the previous point of the to-be-decoded point is Phi, the parent node of the previous point is Pᵢ₋₂, the K directions are the x-direction, the y-direction, and the z-direction. For a process of decoding the coded bitstream of the to-be-decoded point based on absolute values xᵣ, yᵣ, and zᵣ of residual values of the to-be-decoded point Pᵢ and a distance d₀ between the previous point Pᵢ₋₁ and the parent node Pᵢ₋₂ of the previous point to obtain signs of the residual values of the to-be-decoded point, refer to the following description.

If 0 represents a positive sign and 1 represents a negative sign, there are a total of eight sign combinations of the residual values in the x-direction, the y-direction, and the z-direction: 000, 001, 010, 011, 100, 101, 110, and 111. The signs of the residual values are combined with the absolute values xᵣ, yᵣ, and zᵣ of the residual values to obtain eight residual value combinations: (xᵣ, yᵣ, zᵣ), (xᵣ, yᵣ, −zᵣ), (xᵣ, −yᵣ, zᵣ), (xᵣ, −yᵣ, −zᵣ), (−xᵣ, yᵣ, zᵣ), (−xᵣ, yᵣ, −zᵣ), (−xᵣ, −yᵣ, zᵣ), and (−xᵣ, −yᵣ, −zᵣ).

The eight residual value combinations are added to coordinate values (xᵢ₋₁, yᵢ₋₁, zᵢ₋₁) of the previous point Pᵢ₋₁ respectively, to obtain eight points Pⱼ and their coordinate values (xⱼ, yⱼ, zⱼ).

A distance dⱼ from each point Pⱼ to the parent node Pᵢ₋₂ of the previous point Pᵢ₋₁ is calculated.

dⱼ is compared with d₀, and a combination of the signs of the residual values with dⱼ less than do is deleted. N included combinations of the signs of the residual values remain, and are sequentially numbered 0, 1, 2, . . . , N−1.

The bitstream of the to-be-decoded point is decoded based on the included combinations of the signs of the residual values and their numbers, to obtain the signs of the residual values of the to-be-decoded point Pᵢ.

A number of the signs of the residual values may be decoded in a binary form from a most significant bit to a least significant bit. When a p^{th} bit of the number is decoded, it is assumed that the p^{th} bit is 1 and a remaining undecoded bit is 0, and a decimal value of an obtained number is denoted as n. If n>N−1, the p^{th} bit of the number is 0. Otherwise, context-based arithmetic decoding is performed to obtain a value of the p^{th} bit of the number. A next bit continues to be decoded until the number of the signs of the residual values is obtained based on 3 bits being decoded. Corresponding signs of the residual values are found in the included combinations of the signs of the residual values based on the number, to obtain the signs of the residual values of the to-be-decoded point Pᵢ.

Based on the reconstructed residual values of the to-be-decoded point in the K directions and the reconstructed residual sign information of the to-be-decoded point in the K directions being obtained, the reconstructed residual information of the to-be-decoded point may be determined based on the reconstructed residual values of the to-be-decoded point in the K directions and the reconstructed residual sign information of the to-be-decoded point in the K directions. Based on the reconstructed residual information of the to-be-decoded point being determined, the geometry information of the to-be-decoded point may be reconstructed based on the reconstructed residual information of the to-be-decoded point. In some embodiments, predicted geometry information of the to-be-decoded point is obtained, and the geometry information of the to-be-decoded point is reconstructed based on the predicted geometry information of the to-be-decoded point and the reconstructed residual information, to obtain reconstructed geometry information of the to-be-decoded point. The predicted geometry information of the to-be-decoded point is predicted by using a prediction tree. In some embodiments, a prediction tree of the point cloud may be configured for reflecting a connection relationship between points in the point cloud and indicating prediction modes (for example, prediction modes in the predictive coding technologies) of the points in the point cloud. Prediction is performed for the to-be-decoded point based on a prediction mode of the to-be-decoded point, to obtain the predicted geometry information of the to-be-decoded point.

A decoding process in some embodiments are performed by using a context model.

ptn_residual_eq0_flag of the to-be-decoded point in the K directions is parsed by using K1 context models ctx_residual_eq0[k](k=1, 2, . . . , K1). K1 is a positive integer less than or equal to K. When K1 is equal to K, it indicates that context models used in different directions are independent of each other. For example, ptn_residual_eq0_flag in the x-direction, the y-direction, and the z-direction is parsed by using three context models (a first context model, a second context model, and a third context model), the x-direction is associated with the first context model, the y-direction is associated with the second context model, and the z-direction is associated with the third context model. When K1<K, it indicates that context models used in different directions are correlated. For example, ptn_residual_eq0_flag in the x-direction, the y-direction, and the z-direction is parsed by using two context models (a first context model and a second context model), the x-direction and the y-direction are associated with the first context model, and the z-direction is associated with the second context model.

ptn_residual_sign_flag of the to-be-decoded point in the K directions is parsed by using K2 context models ctx_residual_sign[k](k=1, 2, . . . , K2). K2 is a positive integer less than or equal to K. When K2 is equal to K, it indicates that context models used in different directions are independent of each other. When K2<K, it indicates that context models used in different directions are correlated.

B[k] bit values in bit value fields of the to-be-decoded point in the K directions are parsed by using K3×N context models ctxNumBits[k][N] (k=1, 2, . . . , K3). K3 is a positive integer less than or equal to K, and N is a positive integer greater than or equal to B[k]. Similarly, when K3 is equal to K, it indicates that context model groups (including N context models) used in different directions are independent of each other. When K3<K, it indicates that context model groups (including N context models) used in different directions are correlated. The k^{th} direction of the K directions is used as an example. Parsing the B[k] bit values in the bit value field of the to-be-decoded point in the k^{th} direction by using N context models includes any one of the following cases:

The B[k] bit values are parsed by using N independent context models, N being equal to B[k]. A context model used to parse each of the B[k] bit values may be independently selected from the N context models. For example, assuming that B[k]=5, and 5 bit values are represented as b4, b3, b2, b1, and b0, b4 is parsed by using a first context model, b3 is parsed by using a second context model, b2 is parsed by using a third context model, b1 is parsed by using a fourth context model, and b0 is parsed by using a fifth context model.

The B[k] bit values are parsed by using N fully-correlated context models, N being greater than B[k]. A context model used to parse an at bit value of the B[k] bit values may be selected from the N context models depending on parsing results of a−1 bit values before the at bit value, a being a positive integer less than or equal to B[k]. For example, assuming that B[k]=5, and 5 bit values are represented as b4, b3, b2, b1, and b0, parsing the 5 bit values by using N fully-correlated context models may be represented as follows:

$$ctxIdx = 0 for b 0 ;$$

$$ctxIdx = 1 + b 0 for b 1 ;$$

$$ctxIdx = 3 + b 1 b 0 for b 2 ;$$

$$ctxIdx = 7 + b 2 b 1 b 0 for b 3 ; and$$

$$ctxIdx = 15 + b 3 b 2 b 1 b 0 for b 4 .$$

ctxIdx=0 for b0 indicates that b0 is parsed by using a context model numbered 0 in the N context models. ctxIdx=1+b0 for b1 indicates that a context model used to parse b1 is selected depending on a parsing result of b0, or b1 is parsed by using a context model numbered 1+b0 in the N context models. b4, b3, and b2 are similar to b1.

The B[k] bit values are parsed by using N partially-correlated context models, N being greater than B[k]. A context model used to parse an (a1)^{th} bit value of the B[k] bit values may be selected from the N context models depending on a parsing result of a value before the (a1)^{th} bit value, and a context model used to parse an (a2)^{th} bit value of the B[k] bit values is independently selected from the N context models, both a1 and a2 being positive integers less than or equal to B[k], and a^{th} being not equal to a2. For example, assuming that B[k]=5, and 5 bit values are represented as b4, b3, b2, b1, and b0, parsing the 5 bit values by using N partially-correlated context models may be represented as follows:

$$ctxIdx = 0 for b 0 ;$$

$$ctxIdx = 1 + b 0 for b 1 ;$$

$$ctxIdx = 3 + b 1 b 0 for b 2 ;$$

$$ctxIdx = 7 for b 3 ; and$$

$$ctxIdx = 8 for b 4 .$$

ctxIdx=0 for b0 indicates that b0 is parsed by using a context model numbered 0 in the N context models. b4 and b3 are similar to b0. ctxIdx=1+b0 for b1 indicates that a context model used to parse b1 is selected depending on a parsing result of b0, or b1 is parsed by using a context model numbered 1+b0 in the N context models. b2 is similar to b1.

Residual remainder fields (ptn_residual_abs_remaining) of the to-be-decoded point in the K directions are parsed by using K4 context models. When the coding schemes of the to-be-decoded point in the K directions are the first coding scheme or the third coding scheme, ptn_residual_abs_remaining is involved in the parsing process, and ptn_residual_abs_remaining of the to-be-decoded point in the K directions is parsed by using K4 context models. K4 is a positive integer less than or equal to K. When K4 is equal to K, it indicates that context models used in different directions are independent of each other. When K4<K, it indicates that context models used in different directions are correlated.

Number-of-occupied-bits remainder fields (ptn_numbits_remaining) of the to-be-decoded point in the K directions are parsed by using K5 context models. When the coding schemes of the to-be-decoded point in the K directions are the second coding scheme or the third coding scheme, ptn_numbits_remaining is involved in the parsing process, and ptn_numbits_remaining of the to-be-decoded point in the K directions is parsed by using K5 context models. K5 is a positive integer less than or equal to K. When K5 is equal to K, it indicates that context models used in different directions are independent of each other. When K5<K, it indicates that context models used in different directions are correlated.

In some embodiments, when a to-be-decoded point in a point cloud may be decoded, coding data of the point cloud is obtained, a coding scheme of the to-be-decoded point in the point cloud in each direction is determined based on the coding data, and the to-be-decoded point is decoded based on the determined coding scheme. In some embodiments, a proper coding scheme is determined for each direction of the to-be-decoded point for decoding by using the coding data, which may improve geometry decoding efficiency of the point cloud.

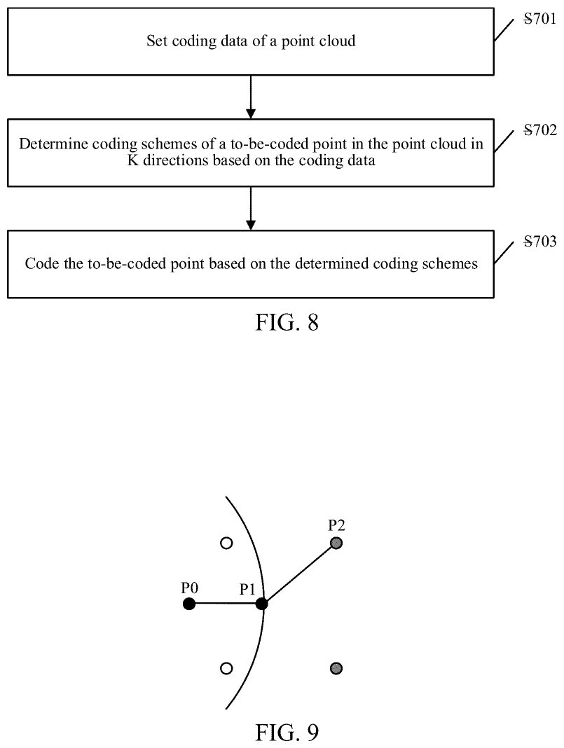

Some embodiments provide a point cloud processing method. The point cloud processing method describes content that a coder side determines a proper coding scheme for a to-be-coded point in a point cloud in each direction, and performs coding based on the determined coding scheme. The point cloud processing method is performed by a computer device. For example, the computer device is the coding device 501 in the point cloud processing system. As shown in FIG. 8, the point cloud processing method includes 701 to 703:

701: Set coding data of a point cloud.

702: Determine coding schemes of a to-be-coded point in the point cloud in K directions based on the coding data.

In 701 and 702, in a coding process of a point cloud, coding data of the point cloud is set, and coding schemes of a to-be-coded point in the point cloud in K directions are determined based on the coding data of the point cloud. A same coding scheme is used for the to-be-coded point in the K directions, or different coding schemes are used for the to-be-coded point in the K directions, K being a positive integer.

When a same coding scheme is used for the to-be-coded point in the K directions, the determining coding schemes of a to-be-coded point in the point cloud in K directions based on the coding data includes but is not limited to any one of the following:

A coder side and a decoder side consider by default that a same coding scheme is used in all of the K directions. In some embodiments, the coding data includes default setting information, the default setting information being set by default by the coder side and the decoder side. In this case, based on the default setting information, it is determined that a default coding scheme is used for the to-be-coded point in the K directions. If the default setting information indicates that the coding schemes in the K directions are the same, a same default coding scheme is used for the to-be-coded point in all of the K directions. In some embodiments, the default setting information further indicates a default coding scheme. For example, the default setting information indicates that the coding schemes of the to-be-coded point in the K directions are the same, and the same coding scheme is a first coding scheme, a second coding scheme, or a third coding scheme.

The coder side sets scheme setting information to determine the coding schemes, the scheme setting information being written in a coding parameter set or a coded bitstream of the point cloud. In some embodiments, the coding data includes scheme setting information. In this case, if the scheme setting information is common to the to-be-coded point in the K directions, it is determined that a same coding scheme is used for the to-be-coded point in the K directions, and a coding scheme common to the to-be-coded point in the K directions is determined based on the scheme setting information common to the to-be-coded point in the K directions.

The scheme setting information includes either or both of a residual division flag field (ptn_residual_divide_flag) and a number-of-occupied-bits division flag field (ptn_numbits_divide_flag). The determining a coding scheme common to the to-be-coded point in the K directions based on the scheme setting information common to the to-be-coded point in the K directions includes any one of the following cases:

When the scheme setting information includes the residual division flag field, and the residual division flag field is set to a target value (for example, the target value is 1) (for example, when ptn_residual_divide_flag is set to 1), it is determined that the coding scheme common to the to-be-coded point in the K directions is the first coding scheme. When the residual division flag field is set to a reference value (for example, the reference value is 0) (for example, when ptn_residual_divide_flag is set to 0), it is determined that the coding scheme common to the to-be-coded point in the K directions is a fourth coding scheme.

When the scheme setting information includes the number-of-occupied-bits division flag field, and the number-of-occupied-bits division flag field is set to the target value (for example, when ptn_numbits_divide_flag is set to 1), it is determined that the coding scheme common to the to-be-coded point in the K directions is the second coding scheme. When the number-of-occupied-bits division flag field is set to the reference value (for example, when ptn_numbits_divide_flag is set to 0), it is determined that the coding scheme common to the to-be-coded point in the K directions is the fourth coding scheme.

When the scheme setting information includes the residual division flag field and the number-of-occupied-bits division flag field, and the residual division flag field and the number-of-occupied-bits division flag field are both set to the target value (for example, when ptn_residual_divide_flag and ptn_numbits_divide_flag are both set to 1), it is determined that the coding scheme common to the to-be-coded point in the K directions is the third coding scheme. When the residual division flag field is set to the target value and the number-of-occupied-bits division flag field is set to the reference value (for example, when ptn_residual_divide_flag is set to 1 and ptn_numbits_divide_flag is set to 0), it is determined that the coding scheme common to the to-be-coded point in the K directions is the first coding scheme. When the residual division flag field is set to the reference value and the number-of-occupied-bits division flag field is set to the target value (for example, when ptn_residual_divide_flag is set to 0 and ptn_numbits_divide_flag is set to 1), it is determined that the coding scheme common to the to-be-coded point in the K directions is the second coding scheme. When the residual division flag field and the number-of-occupied-bits division flag field are both set to the reference values (for example, when ptn_residual_divide_flag and ptn_numbits_divide_flag are both set to 0), it is determined that the coding scheme common to the to-be-coded point in the K directions is the fourth coding scheme.

The coder side sets a decision threshold to decide the coding schemes. In some embodiments, the coding data includes a decision threshold, the decision threshold being set by default by the coder side and the decoder side, or the decision threshold being written in the coding parameter set or the coded bitstream of the point cloud. In this case, scheme decision information is obtained, and the coding schemes of the to-be-coded point in the K directions are decided based on the scheme decision information and the decision threshold.

The decision threshold includes a coded-information threshold, and the scheme decision information includes to-be-coded information of the to-be-coded point in the K directions. In this case, the deciding the coding schemes of the to-be-coded point in the K directions based on the scheme decision information and the decision threshold includes: when a same coding scheme is used for the to-be-coded point in the K directions, determining statistical characteristic information of the to-be-coded information of the to-be-coded point in the K directions, and determining a coding scheme common to the to-be-coded point in the K directions based on a magnitude relationship between the statistical characteristic information and the coded-information threshold. The statistical characteristic information includes any one of an average value of the to-be-coded information of the to-be-coded point in the K directions, a minimum value of the to-be-coded information of the to-be-coded point in the K directions, and a maximum value of the to-be-coded information of the to-be-coded point in the K directions.

In some embodiments, the coded-information threshold includes a residual threshold (t1, t1>0), and the to-be-coded information includes a residual value. Statistical characteristic information of residual values of the to-be-coded point in the K directions may be determined, and a coding scheme common to the to-be-coded point in the K directions may be determined based on a magnitude relationship between the statistical characteristic information and the residual threshold. In some embodiments, when the statistical characteristic information is greater than the residual threshold, it is determined that the coding scheme common to the to-be-coded point in the K directions is the first coding scheme. When the statistical characteristic information is less than or equal to the residual threshold, it is determined that the coding scheme common to the to-be-coded point in the K directions is the fourth coding scheme.

In some embodiments, the coded-information threshold includes a number-of-occupied-bits threshold (t2, t2>0), and the to-be-coded information includes a number of occupied bits of the residual value. Statistical characteristic information of numbers of occupied bits of the residual values of the to-be-coded point in the K directions may be determined, and a coding scheme common to the to-be-coded point in the K directions may be determined based on a magnitude relationship between the statistical characteristic information and the number-of-occupied-bits threshold. In some embodiments, when the statistical characteristic information is greater than the number-of-occupied-bits threshold, it is determined that the coding scheme common to the to-be-coded point in the K directions is the second coding scheme. When the statistical characteristic information is less than or equal to the number-of-occupied-bits threshold, it is determined that the coding scheme common to the to-be-coded point in the K directions is the fourth coding scheme.

The decision threshold includes a quantization threshold, the scheme decision information includes a QP common to the to-be-coded point in the K directions, and a same coding scheme is used for the to-be-coded point in the K directions. In this case, the deciding the coding schemes of the to-be-coded point in the K directions based on the scheme decision information and the decision threshold includes: determining a coding scheme common to the to-be-coded point in the K directions based on a magnitude relationship between the QP and the quantization threshold.

In some embodiments, the quantization threshold includes a first quantization threshold (t3, t3>0). If the QP is less than the first quantization threshold, it is determined that the coding scheme common to the to-be-coded point in the K directions is any one of the first coding scheme, the second coding scheme, or the third coding scheme. If the QP is greater than or equal to the first quantization threshold, it is determined that the coding scheme common to the to-be-coded point in the K directions is the fourth coding scheme.

In some embodiments, the quantization threshold includes a second quantization threshold (t4, t4>0). If the QP is greater than the second quantization threshold, it is determined that the coding scheme common to the to-be-coded point in the K directions is any one of the first coding scheme, the second coding scheme, or the third coding scheme. If the QP is less than or equal to the second quantization threshold, it is determined that the coding scheme common to the to-be-coded point in the K directions is the fourth coding scheme.

In some embodiments, the quantization threshold includes a first quantization threshold (t3, t3>0) and a second quantization threshold (t4, t4>0), the second quantization threshold being less than the first quantization threshold. If the QP is greater than the second quantization threshold and is less than the first quantization threshold, it is determined that the coding scheme common to the to-be-coded point in the K directions is any one of the first coding scheme, the second coding scheme, or the third coding scheme. If the QP is less than or equal to the second quantization threshold or is greater than or equal to the first quantization threshold, it is determined that the coding scheme common to the to-be-coded point in the K directions is the fourth coding scheme.

The decision threshold includes a bounding box threshold (t5), the scheme decision information includes a bounding box size of a prediction tree of the point cloud, and the bounding box size includes sizes in the K directions. In this case, the deciding the coding schemes of the to-be-coded point in the K directions based on the scheme decision information and the decision threshold includes: when a same coding scheme is used for the to-be-coded point in the K directions, determining a target size feature value based on the sizes in the K directions, and determining a coding scheme common to the to-be-coded point in the K directions based on a magnitude relationship between the target size feature value and the bounding box threshold. The target size feature value is a ratio between sizes in any two of the K directions. For example, the bounding box size includes sizes in three directions: an x-direction size BoundingBoxSizeₓ, a y-direction size BoundingBoxSize_{y}, and a z-direction size BoundingBoxSize_{z}, and the target size feature value is a ratio (BoundingBoxSizeₓ/BoundingBoxSize_{z}) between the x-direction size BoundingBoxSizeₓ and the z-direction size BoundingBoxSize_{z}.

The coding schemes determined by setting the decision threshold are written in a form of the scheme setting information in the coding parameter set of the point cloud or the coded bitstream of the point cloud.

When different coding schemes are used for the to-be-coded point in the K directions, the determining coding schemes of a to-be-coded point in the point cloud in K directions based on the coding data of the point cloud includes but is not limited to any one of the following:

The coder side and the decoder side consider by default that different coding schemes are used in the K directions. In some embodiments, the coding data includes default setting information, the default setting information being set by default by the decoder side and the coder side. In this case, based on the default setting information, it is determined that a default coding scheme is used for the to-be-coded point in the K directions. If the default setting information indicates that the coding schemes in the K directions are different, different default coding schemes are used for the to-be-coded point in different directions of the K directions. In some embodiments, the default setting information further indicates a default coding scheme. For example, the default setting information indicates that the coding schemes in the K directions (for example, the x-direction, the y-direction, and the z-direction) are different, and a coding scheme of the to-be-coded point in the x-direction is the first coding scheme, a coding scheme of the to-be-coded point in the y-direction is the second coding scheme, and a coding scheme of the to-be-coded point in the z-direction is the third coding scheme.

The coder side sets scheme setting information to determine the coding schemes, the scheme setting information being written in the coding parameter set or the coded bitstream of the point cloud. In some embodiments, the coding data includes scheme setting information. In this case, if the to-be-coded point has one piece of scheme setting information in each of the K directions, it is determined that different coding schemes are used for the to-be-coded point in the K directions, and a coding scheme of the to-be-coded point in each direction is determined based on the scheme setting information of the to-be-coded point in each direction.

A kai direction of the K directions is used as an example. Scheme setting information of the to-be-coded point in the k^{th} direction includes either or both of a residual division flag field (ptn_residual_divide_flag[k]) and a number-of-occupied-bits division flag field (ptn_numbits_divide_flag[k]), k being a positive integer less than or equal to K. The determining a coding scheme of the to-be-coded point in each direction based on the scheme setting information of the to-be-coded point in each direction includes:

When the scheme setting information includes the residual division flag field, and the residual division flag field of the to-be-coded point in the k^{th} direction is set to a target value (for example, the target value is 1) (for example, when ptn_residual_divide_flag[k] is set to 1), it is determined that a coding scheme of the to-be-coded point in the k^{th} direction is the first coding scheme. When the residual division flag field of the to-be-coded point in the k^{th} direction is set to a reference value (for example, the reference value is 0) (for example, when ptn_residual_divide_flag[k] is set to 0), it is determined that the coding scheme of the to-be-coded point in the k^{th} direction is the fourth coding scheme.

When the scheme setting information includes the number-of-occupied-bits division flag field, and the number-of-occupied-bits division flag field of the to-be-coded point in the k^{th} direction is set to the target value (for example, when ptn_numbits_divide_flag[k] is set to 1), it is determined that the coding scheme of the to-be-coded point in the k^{th} direction is the second coding scheme. When the number-of-occupied-bits division flag field of the to-be-coded point in the k^{th} direction is set to the reference value (for example, when ptn_numbits_divide_flag[k] is set to 0), it is determined that the coding scheme of the to-be-coded point in the k^{th} direction is the fourth coding scheme.

When the scheme setting information includes the residual division flag field and the number-of-occupied-bits division flag field, and the residual division flag field and the number-of-occupied-bits division flag field of the to-be-coded point in the k^{th} direction are both set to the target value (for example, when ptn_residual_divide_flag[k] and ptn_numbits_divide_flag[k] are both set to 1), it is determined that the coding scheme of the to-be-coded point in the k^{th} direction is the third coding scheme. When the residual division flag field of the to-be-coded point in the k^{th} direction is set to the target value and the number-of-occupied-bits division flag field of the to-be-coded point in the k^{th} direction is set to the reference value (for example, when ptn_residual_divide_flag[k] is set to 1 and ptn_numbits_divide_flag[k] is set to 0), it is determined that the coding scheme of the to-be-coded point in the k^{th} direction is the first coding scheme. When the residual division flag field of the to-be-coded point in the k^{th} direction is set to the reference value and the number-of-occupied-bits division flag field of the to-be-coded point in the k^{th} direction is set to the target value (for example, when ptn_residual_divide_flag[k] is set to 0 and ptn_numbits_divide_flag[k] is set to 1), it is determined that the coding scheme of the to-be-coded point in the k^{th} direction is the second coding scheme. When the residual division flag field and the number-of-occupied-bits division flag field of the to-be-coded point in the k^{th} direction are both set to the reference value (for example, when ptn_residual_divide_flag[k] and ptn_numbits_divide_flag[k] are both set to 0), it is determined that the coding scheme of the to-be-coded point in the k^{th} direction is the fourth coding scheme.

The coder side sets a decision threshold to decide the coding schemes. In some embodiments, the coding data includes a decision threshold, the decision threshold being set by default by the coder side and the decoder side, or the decision threshold being written in the coding parameter set or the coded bitstream of the point cloud. In this case, scheme decision information is obtained, and the coding schemes of the to-be-coded point in the K directions are decided based on the scheme decision information and the decision threshold.

The decision threshold includes a coded-information threshold, and the scheme decision information includes to-be-coded information of the to-be-coded point in the K directions. In this case, the deciding the coding schemes of the to-be-coded point in the K directions based on the scheme decision information and the decision threshold includes: when different coding schemes are used for the to-be-coded point in the K directions, determining a coding scheme of the to-be-coded point in a corresponding direction based on a magnitude relationship between the coded-information threshold and to-be-coded information of the to-be-coded point in each direction.

In some embodiments, the coded-information threshold includes a residual threshold (t1, t1>0). The k^{th} direction of the K directions is used as an example. To-be-coded information of the to-be-coded point in the k^{th} direction includes a residual value. A coding scheme of the to-be-coded point in the k^{th} direction may be determined based on a magnitude relationship between the residual threshold and the residual value of the to-be-coded point in the k^{th} direction. In some embodiments, when the residual value of the to-be-coded point in the k^{th} direction is greater than the residual threshold, it is determined that the coding scheme of the to-be-coded point in the k^{th} direction is the first coding scheme. When the residual value of the to-be-coded point in the k^{th} direction is less than or equal to the residual threshold, it is determined that the coding scheme of the to-be-coded point in the k^{th} direction is the fourth coding scheme.

In some embodiments, the coded-information threshold includes a number-of-occupied-bits threshold (t2, t2>0). The k^{th} direction of the K directions is used as an example. To-be-coded information of the to-be-coded point in the k^{th} direction includes a number of occupied bits of a residual value. A coding scheme of the to-be-coded point in the k^{th} direction may be determined based on a magnitude relationship between the number-of-occupied-bits threshold and the number of occupied bits of the residual value of the to-be-coded point in the k^{th} direction. In some embodiments, when the number of occupied bits of the residual value of the to-be-coded point in the k^{th} direction is greater than the number-of-occupied-bits threshold, it is determined that the coding scheme of the to-be-coded point in the k^{th} direction is the second coding scheme. When the number of occupied bits of the residual value of the to-be-coded point in the k^{th} direction is less than or equal to the number-of-occupied-bits threshold, it is determined that the coding scheme of the to-be-coded point in the k^{th} direction is the fourth coding scheme.

The decision threshold includes a bounding box threshold (t5), the scheme decision information includes a bounding box size of a prediction tree of the point cloud, and the bounding box size includes sizes in the K directions. In this case, the deciding the coding schemes of the to-be-coded point in the K directions based on the scheme decision information and the decision threshold includes: when different coding schemes are used for the to-be-coded point in the K directions, determining a size feature value of each of the K directions based on the sizes in the K directions, and determining a coding scheme of the to-be-coded point in a corresponding direction based on a magnitude relationship between the bounding box threshold and the size feature value of each direction. A size feature value of the k^{th} direction is a ratio between a size in the k^{th} direction and a size in another direction (any direction in the K directions except the k^{th} direction). For example, the bounding box size includes sizes in three directions: an x-direction size BoundingBoxSizeₓ, a y-direction size BoundingBoxSize_{y}, and a z-direction size BoundingBoxSize_{z}, and a size feature value of the x-direction is a ratio (BoundingBoxSizeₓ/BoundingBoxSize_{z}) between the x-direction size BoundingBoxSizeₓ and the z-direction size BoundingBoxSize_{z}.

The coding schemes determined by setting the decision threshold are written in a form of the scheme setting information in the coding parameter set of the point cloud or the coded bitstream of the point cloud.

703: Code the to-be-coded point based on the determined coding schemes.

Based on the coding schemes of the to-be-coded point in the K directions being determined, the to-be-coded point may be coded based on the determined coding schemes. Geometric residual information of the to-be-coded point may be obtained, including the geometric residual information of the to-be-coded point including residual values of the to-be-coded point in the K directions and residual sign information of the to-be-coded point in the K directions. The coding the to-be-coded point based on the determined coding schemes includes: coding the residual values of the to-be-coded point in the K directions based on the determined coding schemes. In addition to residual value coding for the to-be-coded point in the K directions, residual sign coding also may be performed for the to-be-coded point in the K directions. The geometric residual information of the to-be-coded point may include signed residual values of the to-be-coded point in the K directions, and during coding, unsigned residual values (for example, absolute values of the residual values) of the to-be-coded point in the K directions may be coded separately from the residual sign information.

The geometric residual information of the to-be-coded point is determined based on real geometry information of the to-be-coded point and predicted geometry information of the to-be-coded point. The predicted geometry information of the to-be-coded point is predicted by using a prediction tree. In some embodiments, a prediction tree of the point cloud may be configured for reflecting a connection relationship between points in the point cloud and indicating prediction modes (for example, prediction modes in the predictive coding technologies) of the points in the point cloud. Prediction is performed for the to-be-coded point based on a prediction mode of the to-be-coded point, to obtain the predicted geometry information of the to-be-coded point.

The k^{th} direction of the K directions is used as an example herein to describe residual value coding processes in different coding schemes:

When the coding scheme of the to-be-coded point in the k^{th} direction is the first coding scheme, the first coding scheme being a coding scheme of coding the residual value of the to-be-coded point in the k^{th} direction after-remainder calculation, a residual value coding process in the first coding scheme includes as follows: performing remainder calculation on the residual value A[k](A[k]=A1[k]×d+A2[k]) of the to-be-coded point in the k^{th} direction, to obtain a residual quotient A1[k] and a residual remainder A2[k]; determining a number B[k] of occupied bits of the residual quotient A1[k], representing the number B[k] of occupied bits by using a number-of-occupied-bits field (for example, ptn_residual_numbits[k]) of the to-be-coded point in the k^{th} direction, and coding the number-of-occupied-bits field; representing the residual remainder A2[k] by using a residual remainder field (for example, ptn_residual_abs_remaining[k]) of the to-be-coded point in the k^{th} direction, and coding the residual remainder field; and representing, by using B[k] bit elements in a bit value field (for example, B[k] bit elements of ptn_residual_value_per[k]) of the to-be-coded point in the k^{th} direction, a value of each of the B[k] bits occupied by the residual quotient A1[k], and coding the B[k] bit elements in the bit value field, d representing a divisor in-remainder calculation, for example, if the remainder calculation is performing division by 2 and obtaining a remainder, d=2. In this manner, the residual value is coded as an after-remainder calculation, instead of directly coding the residual value, which can reduce the volume of coded data, which may improve the geometry coding efficiency of the point cloud.

When the coding scheme of the to-be-coded point in the k^{th} direction is the second coding scheme, the second coding scheme being a coding scheme of coding the number of occupied bits of the residual value of the to-be-coded point in the k^{th} direction after-remainder calculation, a residual value coding process in the second coding scheme includes as follows: determining the number B[k] of occupied bits of the residual value A[k] of the to-be-coded point in the k^{th} direction; performing remainder calculation on the number B[k](B[k]=B1[k]×d+B2[k]) of occupied bits, to obtain a number-of-occupied-bits quotient B1[k] and a number-of-occupied-bits remainder B2[k]; representing the number-of-occupied-bits quotient B1[k] by using a number-of-occupied-bits field (for example, ptn_residual_numbits[k]) of the to-be-coded point in the k^{th} direction, and coding the number-of-occupied-bits field; representing the number-of-occupied-bits remainder B2[k] by using a number-of-occupied-bits remainder field (for example, ptn_numbits_remaining[k]) of the to-be-coded point in the k^{th} direction, and coding the number-of-occupied-bits remainder field; and representing, by using B[k] bit elements in a bit value field (for example, B[k] bit elements of ptn_residual_value_per[k]) of the to-be-coded point in the k^{th} direction, a value of each of the B[k] bits occupied by the residual value A[k] of the to-be-coded point in the k^{th} direction, and coding the B[k] bit elements in the bit value field, d representing a divisor in-remainder calculation, for example, if the remainder calculation is performing division by 2 and obtaining a remainder, d=2. In this manner, the number of occupied bits of the residual value is coded after-remainder calculation, instead of directly coding the residual value, which can reduce the volume of coded data, which may improve the geometry coding efficiency of the point cloud.

When the coding scheme of the to-be-coded point in the k^{th} direction is the third coding scheme, the third coding scheme being a coding scheme of performing remainder calculation on the residual value of the to-be-coded point in the k^{th} direction, performing remainder calculation on a number of occupied bits of a remainder calculation result, and performing coding, a residual value coding process in the third coding scheme includes as follows: performing remainder calculation on the residual value A[k](A[k]=A1[k]×d+A2[k]) of the to-be-coded point in the k^{th} direction, to obtain a residual quotient A1[k] and a residual remainder A2[k]; representing the residual remainder A2[k] by using a residual remainder field (for example, ptn_residual_abs_remaining[k]) of the to-be-coded point in the k^{th} direction, and coding the residual remainder field; and performing remainder calculation on the number B[k](B[k]=B1[k]×d+B2[k]) of occupied bits of the residual quotient A1[k], to obtain a number-of-occupied-bits quotient B1[k] and a number-of-occupied-bits remainder B2[k]; representing the number-of-occupied-bits quotient B1[k] by using a number-of-occupied-bits field (for example, ptn_residual_numbits[k]) of the to-be-coded point in the k^{th} direction, and coding the number-of-occupied-bits field; representing the number-of-occupied-bits remainder B2[k] by using a number-of-occupied-bits remainder field (for example, ptn_numbits_remaining[k]) of the to-be-coded point in the k^{th} direction, and coding the number-of-occupied-bits remainder field; and representing, by using B[k] bit elements in a bit value field (for example, B[k] bit elements of ptn_residual_value_per[k]) of the to-be-coded point in the k^{th} direction, a value of each of the B[k] bits occupied by the residual quotient A1[k], and coding the B[k] bit elements in the bit value field. In this manner, after-remainder calculation is performed on the residual value, remainder calculation is performed on the number of occupied bits of the remainder calculation result, and coding is performed, instead of directly coding the residual value, which can reduce the volume of coded data, which may improve the geometry coding efficiency of the point cloud.

When the coding scheme of the to-be-coded point in the k^{th} direction is the fourth coding scheme, the fourth coding scheme being a coding scheme of directly coding the residual value of the to-be-coded point in the k^{th} direction without remainder calculation, a residual value coding process in the fourth coding scheme includes as follows: determining a number B[k] of occupied bits of the residual value A[k] of the to-be-coded point in the k^{th} direction; representing the number B[k] of occupied bits by using a number-of-occupied-bits field (for example, ptn_residual_numbits[k]) of the to-be-coded point in the k^{th} direction, and coding the number-of-occupied-bits field; and representing, by using B[k] bit elements in a bit value field (for example, B[k] bit elements of ptn_residual_value_per[k]) of the to-be-coded point in the k^{th} direction, a value of each of the B[k] bits occupied by the residual value A[k] of the to-be-coded point in the k^{th} direction, and coding the B[k] bit elements in the bit value field.

After the residual value coding processes are described, residual sign information coding processes are described herein. The performing residual sign coding for the to-be-coded point in the K directions includes any one of the following manners:

Sign information in the K directions is directly coded. In some embodiments, the residual sign information of the to-be-coded point in the K directions is coded.

Sign indication information is set, and a sign association relationship with a previous point is determined. In some embodiments, sign indication information is set, the sign indication information being set by default by the coder side and the decoder side, or the sign indication information being written in the coding parameter set or the coded bitstream of the point cloud. A sign association relationship between the to-be-coded point and a previous point of the to-be-coded point is determined based on a set value of the sign indication information. For example, when the value of the sign indication information is a target value (for example, the target value is 1) (for example, when signFlag=1), it is determined that there is a sign association relationship between the to-be-coded point and the previous point of the to-be-coded point. When the value of the sign indication information is a reference value (for example, the reference value is 0) (for example, when signFlag=0), it is determined that there is no sign association relationship between the to-be-coded point and the previous point of the to-be-coded point. If there is a sign association relationship between the to-be-coded point and the previous point of the to-be-coded point, the residual sign coding of the to-be-coded point in the K directions is determined based on residual sign coding of the previous point of the to-be-coded point in the K directions. For example, the residual sign coding of the to-be-coded point in the K directions is the same as the residual sign coding of the previous point of the to-be-coded point in the K directions. If there is no sign association relationship between the to-be-coded point and the previous point of the to-be-coded point, the residual sign information of the to-be-coded point in the K directions is coded.

The coding the residual sign information of the to-be-coded point in the K directions includes any one of the following:

First: The residual sign information of the to-be-coded point in the K directions is directly coded. In some embodiments, the residual sign information of the to-be-coded point in the K directions is respectively represented by using ptn_residual_sign_flag of the to-be-coded point in the K directions, and ptn_residual_sign_flag of the to-be-coded point in the K directions is coded.

Second: The residual sign information of the to-be-coded point in the K directions is coded by using K2 context models. In some embodiments, the residual sign information of the to-be-coded point in the K directions is respectively represented by using ptn_residual_sign_flag of the to-be-coded point in the K directions, and ptn_residual_sign_flag of the to-be-coded point in the K directions is coded by using K2 context models.

### Third:

Signs (for example, residual sign information) of the absolute values of the residual values (for example, unsigned residual values) are traversed to obtain included signs. As shown in FIG. 9, assuming that P0 is a parent node, P1 is a current point, and P2 is the to-be-coded point, based on an absolute value of a residual value between P2 and P1 being coded, there may be four places for a position of P2: two white points and two gray points. The two white points are directly excluded, and signs corresponding to the two gray points are included.

The included signs are re-numbered, and a total number P of all the included signs is recorded. Assuming that the signs of the residual values are (1, 1, 0), and the excluded signs are (0, 0, 0) and (0, 0, 1), a re-numbering result is shown in the following table, X in the table representing an excluded sign, a number to be coded after the re-numbering is 4, and P=5:

| 000 | 001 | 010 | 011 | 100 | 101 | 110 | 111 |
|---|---|---|---|---|---|---|---|
| X | X | 0 | 1 | 2 | 3 | 4 | 5 |

Binary bits of a number corresponding to the residual values are coded from a most significant bit to a least significant bit. When an i^{th} bit is coded, it is assumed that the i^{th} bit is 1 and a remaining uncoded bit is 0, and a value of a currently formed decimal number is denoted as D. If D>P, the bit cannot be 1, and may not be coded. Otherwise, context-based arithmetic coding is performed on the i^{th} bit.

Using the case in the foregoing table as an example: the number to be coded is 4, and it is known that P=5, a coding process is as follows: The number to be coded is converted to a binary representation 4=100. When the first bit of 100 is coded, if the bit is 1, D=100=4 is less than P, and the first bit is context coded. When the second bit of 100 is coded, if the bit is 1, D=110=6 is greater than P, and the second bit is 0, and may not be coded.

The coding the residual sign information of the to-be-coded point in the K directions includes: representing the residual sign information of the to-be-coded point in the K directions by using K residual sign fields (for example, ptn_residual_sign_flag), and coding the K residual sign fields.

A coding process in some embodiments are performed by using a context model.

K1 context models ctx_residual_eq0[k](k=1, 2, . . . , K1) are designed to code ptn_residual_eq0_flag (for example, the residual sign fields) of the to-be-coded point in the K directions. K1 is a positive integer less than or equal to K. When K1 is equal to K, it indicates that context models used in different directions are independent of each other. For example, ptn_residual_eq0_flag in the x-direction, the y-direction, and the z-direction is coded by using three context models (a first context model, a second context model, and a third context model), the x-direction is associated with the first context model, the y-direction is associated with the second context model, and the z-direction is associated with the third context model. When K1<K, it indicates that context models used in different directions are correlated. For example, ptn_residual_eq0_flag in the x-direction, the y-direction, and the z-direction is coded by using two context models (a first context model and a second context model), the x-direction and the y-direction are associated with the first context model, and the z-direction is associated with the second context model.

K2 context models ctx_residual_sign[k](k=1, 2, . . . , K2) are designed to code ptn_residual_sign_flag of the to-be-coded point in the K directions. K2 is a positive integer less than or equal to K. When K2 is equal to K, it indicates that context models used in different directions are independent of each other. When K2<K, it indicates that context models used in different directions are correlated.

B[k] bit elements in bit value fields of the to-be-coded point in the K directions are coded by using K3×N context models ctxNumBits[k][N](k=1, 2, . . . , K3). K3 is a positive integer less than or equal to K, and N is a positive integer greater than or equal to B[k]. Similarly, when K3 is equal to K, it indicates that context model groups (including N context models) used in different directions are independent of each other. When K3<K, it indicates that context model groups (including N context models) used in different directions are correlated. The k^{th} direction of the K directions is used as an example. Coding the B[k] bit elements in the bit value field of the to-be-coded point in the k^{th} direction by using N context models includes any one of the following cases:

The B[k] bit elements are coded by using N independent context models, N being equal to B[k]. A context model used to code each of the B[k] bit elements may be independently selected from the N context models. For example, assuming that B[k]=5, and 5 bit elements are represented as b4, b3, b2, b1, and b0, b4 is coded by using a first context model, b3 is coded by using a second context model, b2 is coded by using a third context model, b1 is coded by using a fourth context model, and b0 is coded by using a fifth context model.

The B[k] bit elements are coded by using N fully-correlated context models, N being greater than B[k]. A context model used to code an a^{th} bit element of the B[k] bit elements may be selected from the N context models depending on a−1 bit elements before the a^{th} bit element, a being a positive integer less than or equal to B[k]. For example, assuming B[k]=5, and 5 bit elements are represented as b4, b3, b2, b1, and b0, coding the 5 bit elements by using N fully-correlated context models may be represented as follows:

$$ctxIdx = 0 for b 0 ;$$

$$ctxIdx = 1 + b 0 for b 1 ;$$

$$ctxIdx = 3 + b 1 b 0 for b 2 ;$$

$$ctxIdx = 7 + b 2 b 1 b 0 for b 3 ; and$$

$$ctxIdx = 15 + b 3 b 2 b 1 b 0 for b 4 .$$

ctxIdx=0 for b0 indicates that b0 is coded by using a context model numbered 0 in the N context models. ctxIdx=1+b0 for b1 indicates that a context model used to code b1 is selected depending on b0, or b1 is coded by using a context model numbered 1+b0 in the N context models. b4, b3, and b2 are similar to b1.

The B[k] bit elements are coded by using N partially-correlated context models, N being greater than B[k]. A context model used to code an (a1)^{th} bit element of the B[k] bit elements may be selected from the N context models depending on an element before the (a1) bit element, and a context model used to code an (a2)^{th} bit element of the B[k] bit elements may be independently selected from the N context models, both a1 and a2 being positive integers less than or equal to B[k], and a^{th} being not equal to a2. For example, assuming B[k]=5, and 5 bit elements are represented as b4, b3, b2, b1, and b0, coding the 5 bit elements by using N partially-correlated context models may be represented as follows:

$$ctxIdx = 0 for b 0 ;$$

$$ctxIdx = 1 + b 0 for b 1 ;$$

$$ctxIdx = 3 + b 1 b 0 for b 2 ;$$

$$ctxIdx = 7 for b 3 ; and$$

$$ctxIdx = 8 for b 4 .$$

ctxIdx=0 for b0 indicates that b0 is coded by using a context model numbered 0 in the N context models. b4 and b3 are similar to b0. ctxIdx=1+b0 for b1 indicates that a context model used to code b1 is selected depending on b0, or b1 is coded by using a context model numbered 1+b0 in the N context models. b2 is similar to b1.

K4 context models are designed to code residual remainder fields (ptn_residual_abs_remaining) of the to-be-coded point in the K directions. When the coding schemes of the to-be-coded point in the K directions are the first coding scheme or the third coding scheme, ptn_residual_abs_remaining is involved in the coding process, and ptn_residual_abs_remaining of the to-be-coded point in the K directions is coded by using K4 context models. K4 is a positive integer less than or equal to K. When K4 is equal to K, it indicates that context models used in different directions are independent of each other. When K4<K, it indicates that context models used in different directions are correlated.

K5 context models are designed to code number-of-occupied-bits remainder fields (ptn_numbits_remaining) of the to-be-coded point in the K directions. When the coding schemes of the to-be-coded point in the K directions are the second coding scheme or the third coding scheme, ptn_numbits_remaining is involved in the coding process, and ptn_numbits_remaining of the to-be-coded point in the K directions is coded by using K5 context models. K5 is a positive integer less than or equal to K. When K5 is equal to K, it indicates that context models used in different directions are independent of each other. When K5<K, it indicates that context models used in different directions are correlated.

In some embodiments, when a to-be-coded point in a point cloud may be coded, coding data of the point cloud is set, a coding scheme of the to-be-coded point in the point cloud in each direction is determined based on the coding data, and the to-be-coded point is coded based on the determined coding scheme. In some embodiments, a proper coding scheme is determined for each direction of the to-be-coded point for coding by using the coding data, which may improve geometry coding efficiency of the point cloud. In addition, a residual value and/or a number of occupied bits of the residual value may be coded as an after-remainder calculation, which reduces the volume of coded data, which may improve the geometry coding efficiency of the point cloud.

After the point cloud processing solution provided in some embodiments are described, syntax tables corresponding to different coding schemes are described herein. A syntax table of the first coding scheme is shown in Table 1 below:

TABLE 1

```
geometry_predtree_node(nodeIdx) {
  for( k = 0; k < 3; k++ ) {
    ptn_residual_eq0_flag[k]
    if( !ptn_residual_eq0_flag[k] ) {
      ptn_residual_sign_flag[k]
      ptn_residual_abs_remaining[k]
      ptn_residual_numbits[k]
      for(j=0; j< ptn_residual_numbits[k];j++){
        ptn_residual_value_per[k][j]
      }
    }
  }
}
```

A syntax table of the second coding scheme is shown in Table 2 below:

TABLE 2

```
geometry_predtree_node(nodeIdx) {
  for( k = 0; k < 3; k++ ) {
    ptn_residual_eq0_flag[k]
    if( !ptn_residual_eq0_flag[k] ) {
      ptn_residual_sign_flag[k]
      ptn_residual_numbits[k]
      ptn_numbits_remaining[k]
      for(j=0; j< ptn_residual_numbits[k]×d+ ptn_numbits_
      remaining[k];j++){
        ptn_residual_value_per[k][j]
      }
    }
  }
}
```

A syntax table of the third coding scheme is shown in Table 3 below:

TABLE 3

```
geometry_predtree_node(nodeIdx) {
  for( k = 0; k < 3; k++ ) {
    ptn_residual_eq0_flag[k]
    if( !ptn_residual_eq0_flag[k] ) {
      ptn_residual_sign_flag[k]
      ptn_residual_abs_remaining[k]
      ptn_residual_numbits[k]
      ptn_numbits_remaining[k]
      for(j=0; j< ptn_residual_numbits[k]×d+ ptn_numbits_
      remaining[k];j++){
        ptn_residual_value_per[k][j]
      }
    }
  }
}
```

A syntax table of the fourth coding scheme is shown in Table 4 below:

TABLE 4

```
geometry_predtree_node(nodeIdx) {
  for( k = 0; k < 3; k++ ) {
    ptn_residual_eq0_flag[k]
    if( !ptn_residual_eq0_flag[k] ) {
      ptn_residual_sign_flag[k]
      ptn_residual_numbits[k]
      for(j=0; j< ptn_residual_numbits[k];j++){
        ptn_residual_value_per[k][j]
      }
    }
  }
}
```

Table 1 to Table 4 are described herein:

nodeIdx: Indicate a current to-be-coded point in the point cloud.

k: Indicate a k^{th} direction of the to-be-coded point.

ptn_residual_eq0_flag (a residual value indication field): Indicate whether a current residual value (for example, a residual value in the k^{th} direction) is 0. When the field is set to 0, it indicates that the current residual value is 0. When the field is set to 1, it indicates that the current residual value is a non-0 value. The field is present in four coding schemes (for example, the first coding scheme, the second coding scheme, the third coding scheme, and the fourth coding scheme).

ptn_residual_sign_flag (a residual sign field): Indicate a sign of the current residual value. When the field is set to 0, it indicates that the current residual value is a negative number. When the field is set to 1, it indicates that the current residual value is a non-negative number. The field is present in four coding schemes (for example, the first coding scheme, the second coding scheme, the third coding scheme, and the fourth coding scheme).

Ptn_residual_abs_remaining (a residual remainder field): Indicate a remainder value (for example, a residual remainder) obtained after-remainder calculation (for example, performing division by 2 and obtaining a remainder) is performed on the current residual value. The value is 0 or 1. The field is present in the first coding scheme and the third coding scheme.

ptn_residual_numbits field (a number-of-occupied-bits field): Indicate a number of bits occupied by a current to-be-coded value, the current to-be-coded value being the current residual value or a quotient value obtained after-remainder calculation (for example, performing division by 2 and obtaining a remainder) is performed on the current residual value. The field is present in four coding schemes (for example, the first coding scheme, the second coding scheme, the third coding scheme, and the fourth coding scheme).

ptn_numbits_remaining (a number-of-occupied-bits remainder field): Indicate a remainder value (for example, a number-of-occupied-bits remainder) obtained after-remainder calculation (for example, performing division by 2 and obtaining a remainder) is performed on the number of occupied bits. The value is 0 or 1. The field is present in the second coding scheme and the third coding scheme.

ptn_residual_value_per (a bit value field): Indicate a value of each bit in the number of occupied bits. The field is present in four coding schemes (for example, the first coding scheme, the second coding scheme, the third coding scheme, and the fourth coding scheme).

The method in some embodiments are described above. To implement the solution in some embodiments, the following provides an apparatus according to some embodiments.

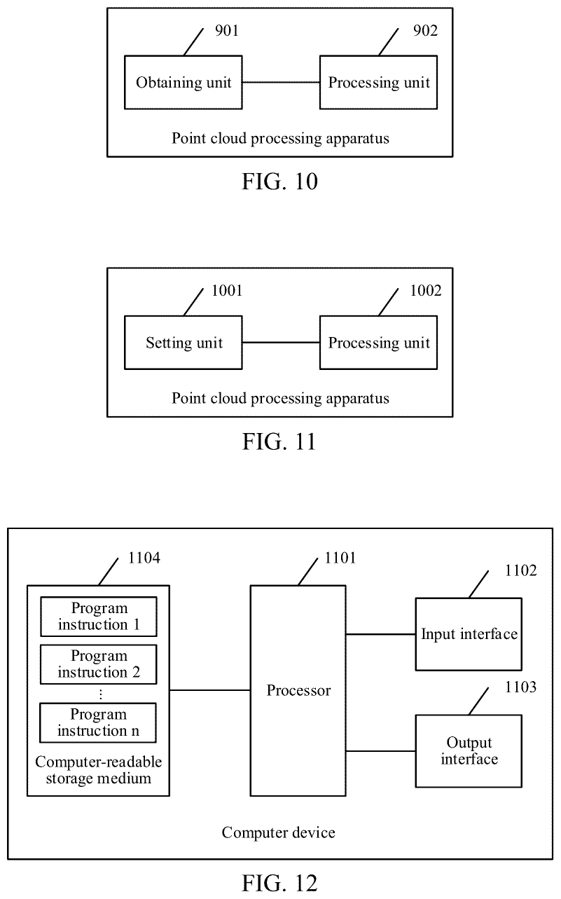

FIG. 10 is a diagram of a structure of a point cloud processing apparatus according to some embodiments. The point cloud processing apparatus is disposed in a computer device provided in some embodiments, the computer device being the decoding device in the method according to some embodiments. The point cloud processing apparatus shown in FIG. 10 is a computer program (including program code) running in the computer device, and the point cloud processing apparatus may be configured to perform some or all operations of the method according to some embodiments as shown in FIG. 7. With reference to FIG. 10, the point cloud processing apparatus includes the following units:
an obtaining unit 901, configured to obtain coding data of a point cloud; and
a processing unit 902, configured to determine coding schemes of a to-be-decoded point in the point cloud in K directions based on the coding data, K being a positive integer; and decode the to-be-decoded point based on the determined coding schemes.

In some embodiments, the coding data includes default setting information, the default setting information being set by default by a decoder side and a coder side; and the processing unit 902 is further configured to: determine, based on the default setting information, that a default coding scheme is used for the to-be-decoded point in the K directions; if the default setting information indicates that the coding schemes in the K directions are the same, a same default coding scheme being used for the to-be-decoded point in all of the K directions; or if the default setting information indicates that the coding schemes in the K directions are different, different default coding schemes being used for the to-be-decoded point in different directions of the K directions.

In some embodiments, the coding data includes scheme setting information, the scheme setting information being parsed out from a coding parameter set of the point cloud or a coded bitstream of the point cloud; and the processing unit 902 is further configured to: if the scheme setting information is common to the to-be-decoded point in the K directions, determine that a same coding scheme is used for the to-be-decoded point in the K directions, and determine a coding scheme common to the to-be-decoded point in the K directions based on the scheme setting information common to the to-be-decoded point in the K directions; or if the to-be-decoded point has one piece of scheme setting information in each of the K directions, determine that different coding schemes are used for the to-be-decoded point in the K directions, and determine a coding scheme of the to-be-decoded point in each direction based on the scheme setting information of the to-be-decoded point in each direction.

In some embodiments, the scheme setting information includes either or both of a residual division flag field and a number-of-occupied-bits division flag field; and the processing unit 902 is further configured to: when the scheme setting information includes the residual division flag field, and a value of the residual division flag field is a target value, determine that the coding scheme common to the to-be-decoded point in the K directions is a first coding scheme; when the scheme setting information includes the number-of-occupied-bits division flag field, and a value of the number-of-occupied-bits division flag field is the target value, determine that the coding scheme common to the to-be-decoded point in the K directions is a second coding scheme; or when the scheme setting information includes the residual division flag field and the number-of-occupied-bits division flag field, and values of the residual division flag field and the number-of-occupied-bits division flag field are both the target value, determine that the coding scheme common to the to-be-decoded point in the K directions is a third coding scheme.

In some embodiments, the coding data includes a decision threshold, the decision threshold being set by default by a decoder side and a coder side, or the decision threshold being parsed out from a coded bitstream of the point cloud; and the processing unit 902 is further configured to: parse out scheme decision information from the coded bitstream of the point cloud; and decide the coding schemes of the to-be-decoded point in the K directions based on the scheme decision information and the decision threshold.

In some embodiments, the decision threshold includes a quantization threshold, the scheme decision information includes a QP common to the to-be-decoded point in the K directions, and a same coding scheme is used for the to-be-decoded point in the K directions; and the processing unit 902 is further configured to: determine a coding scheme common to the to-be-decoded point in the K directions based on a magnitude relationship between the QP and the quantization threshold.

In some embodiments, the quantization threshold includes either or both of a first quantization threshold and a second quantization threshold; and the processing unit 902 is further configured to: when the quantization threshold includes the first quantization threshold, if the QP is less than the first quantization threshold, determine that the coding scheme common to the to-be-decoded point in the K directions is any one of a first coding scheme, a second coding scheme, or a third coding scheme; when the quantization threshold includes the second quantization threshold, if the QP is greater than the second quantization threshold, determine that the coding scheme common to the to-be-decoded point in the K directions is any one of the first coding scheme, the second coding scheme, or the third coding scheme; or when the quantization threshold includes the first quantization threshold and the second quantization threshold, if the QP is greater than the second quantization threshold and is less than the first quantization threshold, determine that the coding scheme common to the to-be-decoded point in the K directions is any one of the first coding scheme, the second coding scheme, or the third coding scheme.

In some embodiments, the decision threshold includes a coding parsing threshold, the scheme decision information includes coding parsing information of the to-be-decoded point in the K directions, and the coding parsing information includes residual parsing information or number-of-occupied-bits parsing information; and the processing unit 902 is further configured to: when a same coding scheme is used for the to-be-decoded point in the K directions, determine statistical characteristic information of the coding parsing information of the to-be-decoded point in the K directions, and determine a coding scheme common to the to-be-decoded point in the K directions based on a magnitude relationship between the statistical characteristic information and the coding parsing threshold; or when different coding schemes are used for the to-be-decoded point in the K directions, determine a coding scheme of the to-be-decoded point in each direction based on a magnitude relationship between the coding parsing threshold and coding parsing information of the to-be-decoded point in each direction; the statistical characteristic information including any one of an average value of the coding parsing information of the to-be-decoded point in the K directions, a minimum value of the coding parsing information of the to-be-decoded point in the K directions, and a maximum value of the coding parsing information of the to-be-decoded point in the K directions.

In some embodiments, the decision threshold includes a bounding box threshold, the scheme decision information includes a bounding box size of a prediction tree of the point cloud, and the bounding box size includes sizes in the K directions; and the processing unit 902 is further configured to: when a same coding scheme is used for the to-be-decoded point in the K directions, determine a target size feature value based on the sizes in the K directions, and determine a coding scheme common to the to-be-decoded point in the K directions based on a magnitude relationship between the target size feature value and the bounding box threshold; or when different coding schemes are used for the to-be-decoded point in the K directions, determine a size feature value of each of the K directions based on the sizes in the K directions, and determine a coding scheme of the to-be-decoded point in a corresponding direction based on a magnitude relationship between the bounding box threshold and the size feature value of each direction.

In some embodiments, the processing unit 902 is further configured to: perform residual value decoding for the to-be-decoded point based on the determined coding schemes, to obtain reconstructed residual values of the to-be-decoded point in the K directions.

In some embodiments, for a k^{th} direction of the K directions, a coding scheme of the to-be-decoded point in the k^{th} direction is a first coding scheme, k being a positive integer less than or equal to K; and the processing unit 902 is further configured to: parse a number-of-occupied-bits field of the to-be-decoded point in the k^{th} direction, to obtain a number B[k] of occupied bits of a residual quotient A1[k] of the to-be-decoded point in the k^{th} direction; parse B[k] bit values in a bit value field of the to-be-decoded point in the k^{th} direction, to obtain the residual quotient A1[k]; parse a residual remainder field of the to-be-decoded point in the k^{th} direction, to obtain a residual remainder A2[k] of the to-be-decoded point in the k^{th} direction; and determine a reconstructed residual value A[k] of the to-be-decoded point in the k^{th} direction based on the residual quotient A1[k] and the residual remainder A2[k].

In some embodiments, for a k^{th} direction of the K directions, a coding scheme of the to-be-decoded point in the k^{th} direction is a second coding scheme; and the processing unit 902 is further configured to: parse a number-of-occupied-bits field of the to-be-decoded point in the k^{th} direction, to obtain a number-of-occupied-bits quotient B1[k] of the to-be-decoded point in the k^{th} direction; parse a number-of-occupied-bits remainder field of the to-be-decoded point in the k^{th} direction, to obtain a number-of-occupied-bits remainder B2[k] of the to-be-decoded point in the k^{th} direction; determine a number B[k] of occupied bits of a reconstructed residual value A[k] of the to-be-decoded point in the k^{th} direction based on the number-of-occupied-bits quotient B1[k] and the number-of-occupied-bits remainder B2[k]; and parse B[k] bit values in a bit value field of the to-be-decoded point in the k^{th} direction, to obtain the reconstructed residual value A[k] of the to-be-decoded point in the k^{th} direction.

In some embodiments, for a k^{th} direction of the K directions, a coding scheme of the to-be-decoded point in the k^{th} direction is a third coding scheme; and the processing unit 902 is further configured to: parse a number-of-occupied-bits field of the to-be-decoded point in the k^{th} direction, to obtain a number-of-occupied-bits quotient B1[k] of the to-be-decoded point in the k^{th} direction; parse a number-of-occupied-bits remainder field of the to-be-decoded point in the k^{th} direction, to obtain a number-of-occupied-bits remainder B2[k] of the to-be-decoded point in the k^{th} direction; determine a number B[k] of occupied bits of a residual quotient A1[k] of the to-be-decoded point in the k^{th} direction based on the number-of-occupied-bits quotient B1[k] and the number-of-occupied-bits remainder B2[k]; parse B[k] bit values in a bit value field of the to-be-decoded point in the k^{th} direction, to obtain the residual quotient A1[k]; parse a residual remainder field of the to-be-decoded point in the k^{th} direction, to obtain a residual remainder A2[k] of the to-be-decoded point in the k^{th} direction; and determine a reconstructed residual value A[k] of the to-be-decoded point in the k^{th} direction based on the residual quotient A1[k] and the residual remainder A2[k].

In some embodiments, when the coding schemes of the to-be-decoded point in the K directions are the first coding scheme or the third coding scheme, corresponding residual remainder fields of the to-be-decoded point in the K directions are parsed by using K4 context models, K4 being a positive integer less than or equal to K.

In some embodiments, when the coding schemes of the to-be-decoded point in the K directions are the second coding scheme or the third coding scheme, corresponding number-of-occupied-bits remainder fields of the to-be-decoded point in the K directions are parsed by using K5 context models, K5 being a positive integer less than or equal to K.

In some embodiments, the processing unit 902 is further configured to: parse the B[k] bit values by using N context models, B[k] being a positive integer and N being a positive integer greater than or equal to B[k].

In some embodiments, the processing unit 902 is further configured to: parse the B[k] bit values by using N independent context models, N being equal to B[k]; a context model used to parse each of the B[k] bit values being independently selected from the N context models.

In some embodiments, the processing unit 902 is further configured to: parse the B[k] bit values by using N fully-correlated context models, N being greater than B[k]; a context model used to parse an a^{th} bit value of the B[k] bit values being selected from the N context models depending on parsing results of a−1 bit values before the a^{th} bit value, a being a positive integer less than or equal to B[k].

In some embodiments, the processing unit 902 is further configured to: parse the B[k] bit values by using N partially-correlated context models, N being greater than B[k]; a context model used to parse an (a1) bit value of the B[k] bit values being selected from the N context models depending on a parsing result of a value before the (a1)^{th} bit value, and a context model used to parse an (a2)^{th} bit value of the B[k] bit values being independently selected from the N context models, both a1 and a2 being positive integers less than or equal to B[k], and a^{th} being not equal to a2.

In some embodiments, reconstructed residual values of the to-be-decoded point in the K directions may be obtained after the to-be-decoded point is decoded based on the determined coding schemes; and the processing unit 902 is further configured to: perform residual sign decoding for the to-be-decoded point in each of the K directions, to obtain reconstructed residual sign information of the to-be-decoded point in the K directions; determine reconstructed residual information of the to-be-decoded point based on the reconstructed residual values of the to-be-decoded point in the K directions and the reconstructed residual sign information of the to-be-decoded point in the K directions; and reconstruct geometry information of the to-be-decoded point based on the reconstructed residual information of the to-be-decoded point.

In some embodiments, the processing unit 902 is further configured to: read residual sign coding of the to-be-decoded point in the K directions from a coded bitstream of the point cloud; and parse the residual sign coding of the to-be-decoded point in the K directions, to obtain the reconstructed residual sign information of the to-be-decoded point in the K directions.

In some embodiments, the processing unit 902 is further configured to: obtain sign indication information, the sign indication information being set by default by a coder side and a decoder side, or the sign indication information being parsed out from a coding parameter set or a coded bitstream of the point cloud; determine a sign association relationship between the to-be-decoded point and a previous point of the to-be-decoded point based on a value of the sign indication information; and if there is a sign association relationship between the to-be-decoded point and the previous point of the to-be-decoded point, determine the reconstructed residual sign information of the to-be-decoded point in the K directions based on reconstructed residual sign information of the previous point of the to-be-decoded point in the K directions; or if there is no sign association relationship between the to-be-decoded point and the previous point of the to-be-decoded point, read residual sign coding of the to-be-decoded point in the K directions from a coded bitstream of the point cloud, and parse the residual sign coding of the to-be-decoded point in the K directions, to obtain the reconstructed residual sign information of the to-be-decoded point in the K directions.

In some embodiments, the processing unit 902 is further configured to: parse the residual sign coding of the to-be-decoded point in the K directions by using K2 context models, to obtain the reconstructed residual sign information of the to-be-decoded point in the K directions, K2 being a positive integer less than or equal to K.

In some embodiments, the processing unit 902 is further configured to: obtain predicted geometry information of the to-be-decoded point; and reconstruct the geometry information of the to-be-decoded point based on the reconstructed residual information of the to-be-decoded point and the predicted geometry information of the to-be-decoded point.

According to some embodiments, some or all of the units of the point cloud processing apparatus shown in FIG. 10 are combined into one or more other units, or one (or more) of the units therein are further divided into a plurality of units of smaller functions. Same operations may be implemented without affecting implementation of technical effects of some embodiments. The units may be obtained through division based on logical functions. In application, a function of one unit may be implemented by a plurality of units, or functions of a plurality of units may be implemented by one unit. In some embodiments, the point cloud processing apparatus includes another unit. In application, these functions may be assisted by another unit, and may be cooperatively implemented by a plurality of units.

According to some embodiments, a computer program (including program code) that can perform some or all operations of the method shown in FIG. 7 is run on a computing device, for example, a computer, including a processing element and a storage element such as a central processing unit (CPU), a random access memory (RAM), and a read-only memory (ROM), to construct the point cloud processing apparatus shown in FIG. 10, and implement the point cloud processing method according to some embodiments. The computer program is recorded in, for example, a computer-readable storage medium, and is loaded into the computer device through the computer-readable storage medium, and run in the computer device.

In some embodiments, when a to-be-decoded point in a point cloud may be decoded, coding data of the point cloud is obtained, a coding scheme of the to-be-decoded point in the point cloud in each direction is determined based on the coding data, and the to-be-decoded point is decoded based on the determined coding scheme. In some embodiments, a proper coding scheme is determined for each direction of the to-be-decoded point for decoding by using the coding data, which may improve geometry decoding efficiency of the point cloud.

FIG. 11 is a diagram of a structure of another point cloud processing apparatus according to some embodiments. The point cloud processing apparatus is disposed in a computer device provided in some embodiments, the computer device being the coding device in the method according to some embodiments. The point cloud processing apparatus shown in FIG. 11 is a computer program (including program code) running in the computer device, and the point cloud processing apparatus may be configured to perform some or all operations of the method according to some embodiments as shown in FIG. 8. With reference to FIG. 11, the point cloud processing apparatus includes the following units:
a setting unit 1001, configured to set coding data of a point cloud; and
a processing unit 1002, configured to determine coding schemes of a to-be-coded point in the point cloud in K directions based on the coding data, K being a positive integer; and code the to-be-coded point based on the determined coding schemes.

In some embodiments, the coding data includes default setting information, the default setting information being set by default by a coder side and a decoder side; and the processing unit 1002 is further configured to: determine, based on the default setting information, that a default coding scheme is used for the to-be-coded point in the K directions; if the default setting information indicates that the coding schemes in the K directions are the same, a same default coding scheme being used for the to-be-coded point in all of the K directions; or if the default setting information indicates that the coding schemes in the K directions are different, different default coding schemes being used for the to-be-coded point in different directions of the K directions.

In some embodiments, the coding data includes scheme setting information, the scheme setting information being written in a coding parameter set of the point cloud or a coded bitstream of the point cloud; and the processing unit 1002 is further configured to: if the scheme setting information is common to the to-be-coded point in the K directions, determine that a same coding scheme is used for the to-be-coded point in the K directions, and determine a coding scheme common to the to-be-coded point in the K directions based on the scheme setting information common to the to-be-coded point in the K directions; or if the to-be-coded point has one piece of scheme setting information in each of the K directions, determine that different coding schemes are used for the to-be-coded point in the K directions, and determine a coding scheme of the to-be-coded point in each direction based on the scheme setting information of the to-be-coded point in each direction.

In some embodiments, the scheme setting information includes either or both of a residual division flag field and a number-of-occupied-bits division flag field; and the processing unit 1002 is further configured to: when the scheme setting information includes the residual division flag field, and the residual division flag field is set to a target value, determine that the coding scheme common to the to-be-coded point in the K directions is a first coding scheme; when the scheme setting information includes the number-of-occupied-bits division flag field, and the number-of-occupied-bits division flag field is set to the target value, determine that the coding scheme common to the to-be-coded point in the K directions is a second coding scheme; or when the scheme setting information includes the residual division flag field and the number-of-occupied-bits division flag field, and the residual division flag field and the number-of-occupied-bits division flag field are both set to the target value, determine that the coding scheme common to the to-be-coded point in the K directions is a third coding scheme.

In some embodiments, the coding data includes a decision threshold, the decision threshold being set by default by a coder side and a decoder side, or the decision threshold being written in a coding parameter set or a coded bitstream of the point cloud; and the processing unit 1002 is further configured to: obtain scheme decision information; and decide the coding schemes of the to-be-coded point in the K directions based on the scheme decision information and the decision threshold.

In some embodiments, the decision threshold includes a quantization threshold, the scheme decision information includes a QP common to the to-be-coded point in the K directions, and a same coding scheme is used for the to-be-coded point in the K directions; and the processing unit 1002 is further configured to: determine a coding scheme common to the to-be-coded point in the K directions based on a magnitude relationship between the QP and the quantization threshold.

In some embodiments, the quantization threshold includes either or both of a first quantization threshold and a second quantization threshold; and the processing unit 1002 is further configured to: when the quantization threshold includes the first quantization threshold, if the QP is less than the first quantization threshold, determine that the coding scheme common to the to-be-coded point in the K directions is any one of a first coding scheme, a second coding scheme, or a third coding scheme; when the quantization threshold includes the second quantization threshold, if the QP is greater than the second quantization threshold, determine that the coding scheme common to the to-be-coded point in the K directions is any one of the first coding scheme, the second coding scheme, or the third coding scheme; or when the quantization threshold includes the first quantization threshold and the second quantization threshold, if the QP is greater than the second quantization threshold and is less than the first quantization threshold, determine that the coding scheme common to the to-be-coded point in the K directions is any one of the first coding scheme, the second coding scheme, or the third coding scheme.

In some embodiments, the decision threshold includes a coded-information threshold, the scheme decision information includes to-be-coded information of the to-be-coded point in the K directions, and the to-be-coded information includes a residual value or a number of occupied bits of the residual value; and the processing unit 1002 is further configured to: when a same coding scheme is used for the to-be-coded point in the K directions, determine statistical characteristic information of the to-be-coded information of the to-be-coded point in the K directions, and determine a coding scheme common to the to-be-coded point in the K directions based on a magnitude relationship between the statistical characteristic information and the coded-information threshold; or when different coding schemes are used for the to-be-coded point in the K directions, determine a coding scheme of the to-be-coded point in each direction based on a magnitude relationship between the coded-information threshold and to-be-coded information of the to-be-coded point in each direction; the statistical characteristic information including any one of an average value of the to-be-coded information of the to-be-coded point in the K directions, a minimum value of the to-be-coded information of the to-be-coded point in the K directions, and a maximum value of the to-be-coded information of the to-be-coded point in the K directions.

In some embodiments, the decision threshold includes a bounding box threshold, the scheme decision information includes a bounding box size of a prediction tree of the point cloud, and the bounding box size includes sizes in the K directions; and the processing unit 1002 is further configured to: when a same coding scheme is used for the to-be-coded point in the K directions, determine a target size feature value based on the sizes in the K directions, and determine a coding scheme common to the to-be-coded point in the K directions based on a magnitude relationship between the target size feature value and the bounding box threshold; or when different coding schemes are used for the to-be-coded point in the K directions, determine a size feature value of each of the K directions based on the sizes in the K directions, and determine a coding scheme of the to-be-coded point in each direction based on a magnitude relationship between the bounding box threshold and the size feature value of each direction.

In some embodiments, the processing unit 1002 is further configured to: obtain geometric residual information of the to-be-coded point, the geometric residual information including residual values of the to-be-coded point in the K directions and residual sign information of the to-be-coded point in the K directions; and code the residual values of the to-be-coded point in the K directions based on the determined coding schemes.

In some embodiments, for a k^{th} direction of the K directions, a coding scheme of the to-be-coded point in the k^{th} direction is a first coding scheme, k being a positive integer less than or equal to K; and the processing unit 1002 is further configured to: perform remainder calculation on a residual value A[k] of the to-be-coded point in the k^{th} direction, to obtain a residual quotient A1[k] and a residual remainder A2[k]; determine a number B[k] of occupied bits of the residual quotient A1[k], represent the number B[k] of occupied bits by using a number-of-occupied-bits field of the to-be-coded point in the k^{th} direction, and code the number-of-occupied-bits field; represent the residual remainder A2[k] by using a residual remainder field of the to-be-coded point in the k^{th} direction, and code the residual remainder field; and represent, by using B[k] bit elements in a bit value field of the to-be-coded point in the k^{th} direction, a value of each of the B[k] bits occupied by the residual quotient A1[k], and code the B[k] bit elements in the bit value field.

In some embodiments, for a k^{th} direction of the K directions, a coding scheme of the to-be-coded point in the k^{th} direction is a second coding scheme, k being a positive integer less than or equal to K; and the processing unit 1002 is further configured to: determine a number B[k] of occupied bits of a residual value A[k] of the to-be-coded point in the k^{th} direction; perform remainder calculation on the number B[k] of occupied bits, to obtain a number-of-occupied-bits quotient B1[k] and a number-of-occupied-bits remainder B2[k]; represent the number-of-occupied-bits quotient B1[k] by using a number-of-occupied-bits field of the to-be-coded point in the k^{th} direction, and code the number-of-occupied-bits field; represent the number-of-occupied-bits remainder B2[k] by using a number-of-occupied-bits remainder field of the to-be-coded point in the k^{th} direction, and code the number-of-occupied-bits remainder field; and represent, by using B[k] bit elements in a bit value field of the to-be-coded point in the k^{th} direction, a value of each of the B[k] bits occupied by the residual value of the to-be-coded point in the k^{th} direction, and code the B1[k] bit elements in the bit value field.

In some embodiments, for a k^{th} direction of the K directions, a coding scheme of the to-be-coded point in the k^{th} direction is a third coding scheme, k being a positive integer less than or equal to K; and the processing unit 1002 is further configured to: perform remainder calculation on a residual value A[k] of the to-be-coded point in the k^{th} direction, to obtain a residual quotient A1[k] and a residual remainder A2[k]; represent the residual remainder A2[k] by using a residual remainder field of the to-be-coded point in the k^{th} direction, and code the residual remainder field; and perform remainder calculation on a number B[k] of occupied bits of the residual quotient A1[k], to obtain a number-of-occupied-bits quotient B1[k] and a number-of-occupied-bits remainder B2[k]; represent the number-of-occupied-bits quotient B1[k] by using a number-of-occupied-bits field of the to-be-coded point in the k^{th} direction, and code the number-of-occupied-bits field; represent the number-of-occupied-bits remainder B2[k] by using a number-of-occupied-bits remainder field of the to-be-coded point in the k^{th} direction, and code the number-of-occupied-bits remainder field; and represent, by using B[k] bit elements in a bit value field of the to-be-coded point in the k^{th} direction, a value of each of the B[k] bits occupied by the residual quotient A1[k], and code the B[k] bit elements in the bit value field.

In some embodiments, when the coding schemes of the to-be-coded point in the K directions are the first coding scheme or the third coding scheme, residual remainder fields of the to-be-coded point in the K directions are coded by using K4 context models, K4 being a positive integer less than or equal to K.

In some embodiments, when the coding schemes of the to-be-coded point in the K directions are the second coding scheme or the third coding scheme, number-of-occupied-bits remainder fields of the to-be-coded point in the K directions are coded by using K5 context models, K5 being a positive integer less than or equal to K.

In some embodiments, the processing unit 1002 is further configured to: code the B[k] bit elements in the bit value field by using N context models, B[k] being a positive integer and N being a positive integer greater than or equal to B[k].

In some embodiments, the processing unit 1002 is further configured to: code the B[k] bit elements in the bit value field by using N independent context models; a context model used to code each bit element in the bit value field being independently selected from the N context models.

In some embodiments, the processing unit 1002 is further configured to: code the B[k] bit elements in the bit value field by using N fully-correlated context models; a context model used to code an a^{th} bit element in the bit value field being selected from the N context models depending on a−1 bit elements before the a^{th} bit element, a being a positive integer less than or equal to B[k].

In some embodiments, the processing unit 1002 is further configured to: code the B[k] bit elements in the bit value field by using N partially-correlated context models; a context model used to code an (a1)^{th} bit element in the bit value field being selected from the N context models depending on an element before the (a1)^{th} bit element, and a context model used to code an (a2)^{th} bit element in the bit value field being independently selected from the N context models, both a1 and a2 being positive integers less than or equal to B[k], and a^{th} being not equal to a2.

In some embodiments, the processing unit 1002 is further configured to: obtain predicted geometry information of the to-be-coded point; and determine geometric residual information of the to-be-coded point based on real geometry information of the to-be-coded point and the predicted geometry information of the to-be-coded point.

In some embodiments, the processing unit 1002 is further configured to: perform residual sign coding for the to-be-coded point in the K directions.

In some embodiments, the processing unit 1002 is further configured to: code the residual sign information of the to-be-coded point in the K directions.

In some embodiments, the processing unit 1002 is further configured to: set sign indication information, the sign indication information being set by default by a coder side and a decoder side, or the sign indication information being written in a coding parameter set or a coded bitstream of the point cloud; determine a sign association relationship between the to-be-coded point and a previous point of the to-be-coded point based on a set value of the sign indication information; and if there is a sign association relationship between the to-be-coded point and the previous point of the to-be-coded point, determine the residual sign coding of the to-be-coded point in the K directions based on residual sign coding of the previous point of the to-be-coded point in the K directions; or if there is no sign association relationship between the to-be-coded point and the previous point of the to-be-coded point, code residual sign information of the to-be-coded point in the K directions.

In some embodiments, the processing unit 1002 is further configured to: code the residual sign information of the to-be-coded point in the K directions by using K2 context models, K2 being a positive integer less than or equal to K.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to cause the processor to perform the respective operations of the corresponding unit.

According to some embodiments, a computer program (including program code) that can perform some or all operations of the method shown in FIG. 8 is run on a computing device, for example, a computer, including a processing element and a storage element such as a CPU, a RAM, and a ROM, to construct the point cloud processing apparatus shown in FIG. 11, and implement the point cloud processing method according to some embodiments. The computer program is recorded in, for example, a computer-readable storage medium, and is loaded into the computer device through the computer-readable storage medium, and run in the computer device.

In some embodiments, when a to-be-coded point in a point cloud may be coded, coding data of the point cloud is set, a coding scheme of the to-be-coded point in the point cloud in each direction is determined based on the coding data, and the to-be-coded point is coded based on the determined coding scheme. In some embodiments, a proper coding scheme is determined for each direction of the to-be-coded point for coding by using the coding data, which may improve geometry coding efficiency of the point cloud.

Some embodiments provide a computer device. The computer device may be the decoding device or coding device. FIG. 12 is a diagram of a structure of a computer device according to some embodiments. The computer device shown in FIG. 12 includes at least a processor 1101, an input interface 1102, an output interface 1103, and a computer-readable storage medium 1104. The processor 1101, the input interface 1102, the output interface 1103, and the computer-readable storage medium 1104 may be connected through a bus or in another manner.

The computer-readable storage medium 1104 is stored in a memory of the computer device, the computer-readable storage medium 1104 may be configured to store a computer program, the computer program includes a computer instruction, and the processor 1101 may be configured to execute the program instruction stored in the computer-readable storage medium 1104. The processor 1101 (or referred to as a CPU) is a computing core and a control core of the computer device, which may be configured to implement one or more computer instructions, and may be configured to load and execute one or more computer instructions to implement a corresponding method flow or corresponding function.

Some embodiments provide a computer-readable storage medium (memory). The computer-readable storage medium is a memory device in a computer device, and may be configured to store a program and data. The computer-readable storage medium herein includes an internal storage medium in the computer device, and may also include an extended storage medium supported by the computer device. The computer-readable storage medium provides a storage space, the storage space storing an operating system of the computer device. Moreover, the storage space further stores one or more computer instructions loaded and executed by a processor. The one or more computer instructions may be one or more computer programs (including program code). The computer-readable storage medium herein is a high-speed RAM, or is a non-volatile memory, for example, at least one magnetic disk storage, or in some embodiments, may be at least one computer-readable storage medium located far away from the processor.

In some embodiments, the one or more computer instructions stored in the computer-readable storage medium 1104 are loaded and executed by the processor 1101 to implement corresponding operations of the point cloud processing method shown in FIG. 7 or FIG. 8. The computer instruction in the computer-readable storage medium 1104 may be loaded and executed by the processor 1101 to perform the point cloud processing method according to some embodiments.

In addition, a computer program product or a computer program is provided. The computer program product or the computer program includes a computer instruction, the computer instruction being stored in a computer-readable storage medium. A processor of a computer device reads the computer instruction from the computer-readable storage medium, and the processor executes the computer instruction, to cause the computer device to perform the point cloud processing method according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A point cloud processing method, performed by a decoding device, the method comprising:
obtaining coding data of a point cloud;
determining a plurality of coding schemes of a first point to be decoded in the point cloud, in a plurality of K directions, based on the coding data; and
decoding the first point based on the determined plurality of coding schemes,
wherein K is a positive integer.

2. The method according to claim 1, wherein the coding data includes default setting information,
wherein the determining the plurality of coding schemes comprises:
determining, based on the default setting information, that a default coding scheme is used for the first point in the plurality of K directions;
based on the default setting information indicating the plurality of coding schemes in the plurality of K directions are the same, using a same default coding scheme for the first point in all of the plurality of K directions; and
based on the default setting information indicating the plurality of coding schemes in the plurality of K directions are different, using different default coding schemes for the first point in different directions of the plurality of K directions, and
wherein the default setting information is set by default by a decoder side and a coder side.

3. The method according to claim 1, wherein the coding data includes scheme setting information,
wherein the determining the plurality of coding schemes comprises:
based on the scheme setting information being common to the first point in the plurality of K directions:
determining a same coding scheme is used for the first point in the plurality of K directions, and
determining a first coding scheme common to the first point in the plurality of K directions based on the scheme setting information common to the first point in the plurality of K directions; and
based on the first point having one piece of scheme setting information in each of the plurality of K directions:
determining different coding schemes are used for the first point in the plurality of K directions, and
determining a second coding scheme of the first point in each direction based on the scheme setting information of the first point in each direction, and
wherein the scheme setting information is determined from at least one of a coding parameter set of the point cloud or a coded bitstream of the point cloud.

4. The method according to claim 3, wherein the scheme setting information includes at least one of a first field that is a residual division flag field or a second field that is a number-of-occupied-bits division flag field, and
wherein the determining the first coding scheme comprises:
determining the first coding scheme is a third coding scheme based on:
the scheme setting information including the first field, and
a first value of the first field being a target value;
determining the first coding scheme is a fourth coding scheme based on:
the scheme setting information including the second field, and
a second value of the second field being the target value; and
determining the first coding scheme is a fifth coding scheme based on:
the scheme setting information including the first field and the second field, and
the first value and the second value being the target value.

5. The method according to claim 1, wherein the coding data includes a decision threshold,
wherein the determining the plurality of coding schemes comprises:
parsing out scheme decision information from a coded bitstream; and
deciding the plurality of coding schemes of the first point in the plurality of K directions based on the scheme decision information and the decision threshold, and
wherein the decision threshold is set by default by a decoder side and a coder side, or the decision threshold is determined from the coded bitstream.

6. The method according to claim 5, wherein the decision threshold includes a quantization threshold,
wherein the scheme decision information includes a quantization parameter common to the first point in the plurality of K directions,
wherein a same coding scheme is used for the first point in the plurality of K directions, and
wherein the deciding the plurality of coding schemes comprises determining a sixth coding scheme common to the first point in the plurality of K directions based on a first magnitude relationship between the quantization parameter and the quantization threshold.

7. The method according to claim 6, wherein the quantization threshold includes at least one of a first quantization threshold or a second quantization threshold, and
wherein the determining the sixth coding scheme comprises determining the first coding scheme is any one of a third coding scheme, a fourth coding scheme, or a fifth coding scheme based on:
the quantization threshold including the first quantization threshold and the quantization parameter being less than the first quantization threshold,
the quantization threshold including the second quantization threshold and the quantization parameter being greater than the second quantization threshold, or
the quantization threshold including the first quantization threshold and the second quantization threshold and the quantization parameter being greater than the second quantization threshold and less than the first quantization threshold.

8. The method according to claim 5, wherein the decision threshold includes a coding parsing threshold,
wherein the scheme decision information includes first coding parsing information of the first point in the plurality of K directions,
wherein the first coding parsing information includes residual parsing information or number-of-occupied-bits parsing information, and
wherein the deciding the plurality of coding schemes comprises:
based on a same coding scheme being used for the first point in the plurality of K directions:
determining statistical characteristic information of the first coding parsing information; and
determining a seventh coding scheme common to the first point in the plurality of K directions based on a second magnitude relationship between the statistical characteristic information and the coding parsing threshold; or
based on different coding schemes being used for the first point in the plurality of K directions:
determining an eighth coding scheme of the first point in each direction based on a third magnitude relationship between the coding parsing threshold and second coding parsing information of the first point in each direction, and
wherein the statistical characteristic information includes at least one of an average value of the first coding parsing information, a minimum value of the first coding parsing information, and a maximum value of the first coding parsing information.

9. The method according to claim 5, wherein the decision threshold includes a bounding box threshold,
wherein the scheme decision information includes a bounding box size of a prediction tree of the point cloud,
wherein the bounding box size includes sizes in the plurality of K directions, and
wherein the deciding the plurality of coding schemes comprises:
based on a same coding scheme being used for the first point in the plurality of K directions:
determining a target size feature value based on the sizes in the plurality of K directions, and
determining a ninth coding scheme common to the first point in the plurality of K directions based on a fourth magnitude relationship between the target size feature value and the bounding box threshold; or
based on different coding schemes being used for the first point in the plurality of K directions:
determining a size feature value of each of the plurality of K directions based on the sizes in the plurality of K directions, and
determining a tenth coding scheme of the first point in each direction based on a fifth magnitude relationship between the bounding box threshold and the size feature value of each direction.

10. The method according to claim 1, wherein the decoding the first point comprises performing residual value decoding for the first point in each of the plurality of K directions based on the determined plurality of coding schemes, to obtain reconstructed residual values of the first point in the plurality of K directions.

11. A point cloud processing apparatus, comprising:
at least one memory configured to store computer program code;
at least one processor configured to read the program code and operate as instructed by the program code, the program code comprising:
obtaining code configured to cause at least one of the at least one processor to obtain coding data of a point cloud;
determining code configured to cause at least one of the at least one processor to determine a plurality of coding schemes of a first point to be decoded in the point cloud in a plurality of K directions, based on the coding data, and
decoding code configured to cause at least one of the at least one processor to decode the first point based on the determined plurality of coding schemes,
wherein K is a positive integer.

12. The point cloud processing apparatus according to claim 11, wherein the coding data comprises default setting information,
wherein the determining code is configured to cause at least one of the at least one processor to:
determine, based on the default setting information, that a default coding scheme is used for the first point in the plurality of K directions;
based on the default setting information indicating the plurality of coding schemes in the plurality of K directions are the same, use a same default coding scheme for the first point in all of the plurality of K directions; and
based on the default setting information indicating the plurality of coding schemes in the plurality of K directions are different, use different default coding schemes for the first point in different directions of the plurality of K directions, and
wherein the default setting information is set by default by a decoder side and a coder side.

13. The point cloud processing apparatus according to claim 11, wherein the coding data comprises scheme setting information,
wherein the determining code is configured to cause at least one of the at least one processor to:
based on the scheme setting information being common to the first point in the plurality of K directions:
determine a same coding scheme is used for the first point in the plurality of K directions, and
determine a first coding scheme common to the first point in the plurality of K directions based on the scheme setting information common to the first point in the plurality of K directions; and
based on the first point having one piece of scheme setting information in each of the plurality of K directions:
determine different coding schemes are used for the first point in the plurality of K directions, and
determine a second coding scheme of the first point in each direction based on the scheme setting information of the first point in each direction, and
wherein the scheme setting information is determined from at least one of a coding parameter set of the point cloud or a coded bitstream of the point cloud.

14. The point cloud processing apparatus according to claim 13, wherein the scheme setting information comprises at least one of a first field that is a residual division flag field or a second field that is a number-of-occupied-bits division flag field, and
wherein the first coding scheme is determined based on:
a determination that the first coding scheme is a third coding scheme based on:
the scheme setting information including the first field, and
a first value of the first field being a target value;
a determination that the first coding scheme is a fourth coding scheme based on:
the scheme setting information including the second field, and
a second value of the second field being the target value; and
a determination that the first coding scheme is a fifth coding scheme based on:
the scheme setting information including the first field and the second field, and
the first value and the second value being the target value.

15. The point cloud processing apparatus according to claim 11, wherein the coding data comprises a decision threshold,
wherein the determining code comprises:
parsing code configured to cause at least one of the at least one processor to parse out scheme decision information from a coded bitstream; and
deciding code configured to cause at least one of the at least one processor to decide the plurality of coding schemes of the first point in the plurality of K directions based on the scheme decision information and the decision threshold, and
wherein the decision threshold is set by default by a decoder side and a coder side, or the decision threshold is determined from the coded bitstream.

16. The point cloud processing apparatus according to claim 15, wherein the decision threshold comprises a quantization threshold,
wherein the scheme decision information comprises a quantization parameter common to the first point in the plurality of K directions,
wherein a same coding scheme is used for the first point in the plurality of K directions, and
wherein the deciding code is configured to cause at least one of the at least one processor to determine a sixth coding scheme common to the first point in the plurality of K directions based on a first magnitude relationship between the quantization parameter and the quantization threshold.

17. The point cloud processing apparatus according to claim 16, wherein the quantization threshold comprises at least one of a first quantization threshold or a second quantization threshold, and
wherein the deciding code is configured to cause at least one of the at least one processor to determine the sixth coding scheme based on determining the first coding scheme is any one of a third coding scheme, a fourth coding scheme, or a fifth coding scheme based on:
the quantization threshold including the first quantization threshold and the quantization parameter being less than the first quantization threshold,
the quantization threshold including the second quantization threshold and the quantization parameter being greater than the second quantization threshold, or
the quantization threshold including the first quantization threshold and the second quantization threshold and the quantization parameter being greater than the second quantization threshold and less than the first quantization threshold.

18. The point cloud processing apparatus according to claim 15, wherein the decision threshold comprises a coding parsing threshold,
wherein the scheme decision information comprises first coding parsing information of the first point in the plurality of K directions,
wherein the first coding parsing information comprises residual parsing information or number-of-occupied-bits parsing information, and
wherein the deciding code is configured to cause at least one of the at least one processor to:
based on a same coding scheme being used for the first point in the plurality of K directions:
determine statistical characteristic information of the first coding parsing information; and
determine a seventh coding scheme common to the first point in the plurality of K directions based on a second magnitude relationship between the statistical characteristic information and the coding parsing threshold; or
based on different coding schemes being used for the first point in the plurality of K directions:
determine an eighth coding scheme of the first point in each direction based on a third magnitude relationship between the coding parsing threshold and second coding parsing information of the first point in each direction, and
wherein the statistical characteristic information comprises at least one of an average value of the first coding parsing information, a minimum value of the first coding parsing information, and a maximum value of the first coding parsing information.

19. The point cloud processing apparatus according to claim 15, wherein the decision threshold comprises a bounding box threshold,
wherein the scheme decision information comprises a bounding box size of a prediction tree of the point cloud,
wherein the bounding box size comprises sizes in the plurality of K directions, and
wherein the deciding code is configured to cause at least one of the at least one processor to:
based on a same coding scheme being used for the first point in the plurality of K directions:
determine a target size feature value based on the sizes in the plurality of K directions, and
determine a ninth coding scheme common to the first point in the plurality of K directions based on a fourth magnitude relationship between the target size feature value and the bounding box threshold; or
based on different coding schemes being used for the first point in the plurality of K directions:
determine a size feature value of each of the plurality of K directions based on the sizes in the plurality of K directions, and
determine a tenth Scoding scheme of the first point in each direction based on a fifth magnitude relationship between the bounding box threshold and the size feature value of each direction.

20. A non-transitory computer-readable storage medium, storing computer code which, when executed by at least one processor, causes the at least one processor to at least:
obtain coding data of a point cloud;
determine a plurality of coding schemes of a first point to be decoded in the point cloud in a plurality of K directions, based on the coding data, and
decode the first point based on the determined plurality of coding schemes,
wherein K is a positive integer.
